(19) United States
(12) Patent Application Publication
(10) Pub. No.: US 2012/0301760 A1
(43) Pub. Date: Nov. 29, 2012

(54) NONAQUEOUS ELECTROLYTE SECONDARY BATTERY WITH AN ELECTROLYTE INCLUDING A LITHIUM BORON COMPOUND

(75) Inventor: Tetsuya Murai, Kyoto-shi (JP)

(73) Assignees: SANYO GS SOFT ENERGY CO., LTD., Kyoto-shi (JP); SANYO ELECTRIC CO., LTD., Osaka (JP)

(21) Appl. No.: 13/570,629

(22) Filed: Aug. 9, 2012

Related U.S. Application Data
(63) Continuation of application No. 11/883,577, filed on Aug. 2, 2007.

(30) Foreign Application Priority Data
Feb. 3, 2005 (JP) 2005-27977

(51) Int. Cl. H01M 4/00

(52) U.S. Cl. 429/94

(57) ABSTRACT

A nonaqueous electrolyte secondary battery has a positive electrode containing a lithium complex oxide, a negative electrode which adsorbs/desorbs lithium, and an electrolyte, and not less than 0.1% by mass and not more than 2% by mass of one or more kinds of compounds selected from LiFOB and LiBOB, or not less than 0.01% by mass and not more than 2% by mass of LiBF₄, and not less than 0.1% by mass and not more than 4% by mass of a aromatic compound, respectively relative to the total mass of the electrolyte, are added to the electrolyte in order to suppress decrease in the charge/discharge cycle life property and swelling of a battery when left in high temperature environments.

### CROSS-REFERENCE TO RELATED APPLICATION

This application is a continuation application of U.S. application Ser. No. 11/883,577, filed Aug. 2, 2007, which is a National Stage Application of PCT/JP2006/301830, filed Feb. 3, 2006, and is based upon and claims the priority of the prior Japanese Patent Application No. 2005-027977, filed Feb. 3, 2005, the entire contents of which are incorporated herein by reference.

### TECHNICAL FIELD

The present invention relates to a nonaqueous electrolyte secondary battery having a positive electrode containing a lithium complex oxide, a negative electrode which adsorbs/desorbs lithium, and an electrolyte.

### BACKGROUND ART

As electrolyte salts of lithium ion batteries, LiPF6 is generally used. As other electrolyte salts, also LiBF4 is used, and LiPF5 is also used in admixture with LiBF4 in some cases (see, e.g., Patent Document 1). In the case of use of LiPF6 and LiBF4 in admixture, it is said that electrochemical stability is high and, high electric conductivity is shown in a wider temperature range. There is also suggested LiFOB of the formula (i) or LiBOB of the formula (2) as a lithium salt containing boron.

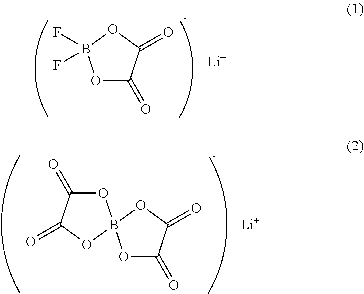

[Patent Document 1] Japanese Patent Application Laid-Open No. 2004-103433

### DISCLOSURE OF THE INVENTION

However, when LiPF₆ is used in admixture with LiBF₄, there occur a problem of increase in swelling of a battery when left in high temperature environments, and a problem of significant decrease in output property in charge/discharge cycle (charge/discharge cycle life property), even if the mixing amount is very small. In particular, decrease in charge/discharge cycle life property is a large problem. Also in the case of use of LiFOB or LiBOB in admixture with LiPF₆, the above-described problems occur like in the case of use of LiBF₄.

The present invention has been made with the aim of solving the above problem, and it is an object of the present invention to provide a nonaqueous electrolyte secondary battery which can suppress decrease in the charge/discharge cycle life property and swelling of a battery when left in high temperature environments, by inclusion of one or more kinds of compounds selected from the group consisting of compounds (LiFOB) of the formula (1) and compounds (LiBOB) of the formula (2) in an amount of not less than 0.1% by mass and not more than 2% by mass relative to the total mass of the electrolyte, and an aromatic compound in an amount of not less than 0.1% by mass and not more than 4% by mass relative to the total mass of the electrolyte.

The present invention has another object of providing a nonaqueous electrolyte secondary battery which can suppress decrease in the charge/discharge cycle life property and swelling of a battery when left in high temperature environments without causing problems of the nonaqueous electrolyte secondary battery, by addition of one or more kinds of aromatic compounds selected from the group consisting of biphenyl, cyclohexylbenzene, 2,4-difluoroanisole, 2-fluorobiphenyl, tertiary amylbenzene, toluene, ethylbenzene, 4-fluorodiphenyl ether and triphenyl phosphate to an electrolyte.

The present invention has another object of providing a nonaqueous electrolyte secondary battery which can decrease the initial battery thickness by inclusion of one or more kinds of compounds selected from the group consisting of vinylene carbonate, vinylethylene carbonate, phenylethylene carbonate and cyclic carboxylic anhydrides in an amount of not less than 0.1% by mass and not more than 2% by mass relative to the total mass of the electrolyte.

The present invention has another object of providing a nonaqueous electrolyte secondary battery which has high electrochemical stability of the electrolyte and improve in quality of the battery by inclusion of LiBF₄.

The present invention has another object of providing a nonaqueous electrolyte secondary battery which can suppress decrease in the charge/discharge cycle life property and swelling of a battery when left in high temperature environments by inclusion of LiBF₄ in an amount of not less than 0.01% by mass and not more than 2% by mass relative to the total mass of the electrolyte, and one or more kinds of compounds selected from the group consisting of biphenyl, 2,4-difluoroanisole, 2-fluorobiphenyl, toluene, ethylbenzene, 4-fluorodiphenyl ether and triphenyl phosphate in an amount of not less than 0.1% by mass and not more than 4% by mass relative to the total mass of the electrolyte.

The present invention has another object of providing a nonaqueous electrolyte secondary battery which can decrease the initial battery thickness by inclusion of one or more kinds of compounds selected from the group consisting of vinylene carbonate, vinylethylene carbonate, phenylethylene carbonate and cyclic carboxylic anhydrides in an amount of not less than 0.1% by mass and not more than 2% by mass relative to the total mass of the electrolyte.

The present invention has another object of providing a nonaqueous electrolyte secondary battery which can suppress decrease in the charge/discharge cycle life property and swelling of a battery when left in high temperature environments and decrease the initial battery thickness by inclusion of LiBF₄ in an amount of not less than 0.01% by mass and not more than 2% by mass relative to the total mass of the electrolyte, an aromatic compound in an amount of not less than 0.1% by mass and not more than 4% by mass relative to the total mass of the electrolyte, and one or more kinds of compounds selected from the group consisting of vinylethylene carbonate, phenylethylene carbonate and cyclic carboxylic anhydrides in an amount of not less than 0.1% by mass and not more than 2% by mass relative to the total mass of the electrolyte.

The nonaqueous electrolyte secondary battery according to the first aspect is characterized in that a nonaqueous electrolyte secondary battery, comprising a positive electrode containing a complex oxide of the composition formula LiₓMO₂ or Li_{y} M₂O₄ (wherein, M represents one or more kinds of transition metals, 0≦x≦1, 0≦y≦2), a negative electrode which adsorbs/desorbs lithium, and an electrolyte, wherein said electrolyte contains one or more kinds of compounds selected from the group consisting of compounds of the formula (1) and compounds of the formula (2) in an amount of not less than 0.1% by mass and not more than 2% by mass relative to the total mass of the electrolyte, and an aromatic compound in an amount of not less than 0.1% by mass and not more than 4% by mass relative to the total mass of the electrolyte.

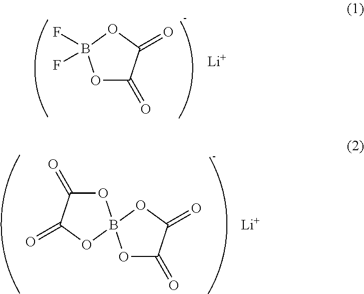

The nonaqueous electrolyte secondary battery according to the second aspect is characterized in that said aromatic compound includes one or more kinds of compounds selected from the group consisting of biphenyl, cyclohexylbenzene, 2,4-difluoroanisole, 2-fluorobiphenyl, tertiary amylbenzene, toluene, ethylbenzene, 4-fluorodiphenyl ether and triphenyl phosphate, in the first aspect.

The nonaqueous electrolyte secondary battery according to the third aspect is characterized in that said electrolyte contains one or more kinds of compounds selected from the group consisting of vinylene carbonate, vinylethylene carbonate, phenylethylene carbonate and cyclic carboxylic anhydrides in an amount of not less than 0.1% by mass and not more than 2% by mass relative to the total mass of the electrolyte, in the first or second aspect.

The nonaqueous electrolyte secondary battery according to the fourth aspect is characterized in that the electrolyte contains LiBF₄, in any one of the first to third aspects.

The nonaqueous electrolyte secondary battery according to the fifth aspect is characterized in that a nonaqueous electrolyte secondary battery, comprising a positive electrode containing a complex oxide of the composition formula LiₓMO₂ or Li_{y} M₂O₄ (wherein, M represents one or more kinds of transition metals, 0≦x≦1, 0≦y≦2), a negative electrode which adsorbs/desorbs lithium, and an electrolyte, wherein said electrolyte contains LiBF₄ in an amount of not less than 0.01% by mass and not more than 2% by mass relative to the total mass of the electrolyte, and one or more kinds of compounds selected from the group consisting of biphenyl, 2,4-difluoroanisole, 2-fluorobiphenyl, toluene, ethylbenzene, 4-fluorodiphenyl ether and triphenyl phosphate in an amount of not less than 0.1% by mass and not more than 4% by mass relative to the total mass of the electrolyte.

The nonaqueous electrolyte secondary battery according to the sixth aspect is characterized in that the electrolyte contains one or more kinds of compounds selected from the group consisting of vinylene carbonate, vinylethylene carbonate, phenylethylene carbonate and cyclic carboxylic anhydrides in an amount of not less than 0.1% by mass and not more than 2% by mass relative to the total mass of the electrolyte, in the fifth aspect.

The nonaqueous electrolyte secondary battery according to the seventh aspect is characterized in that a nonaqueous electrolyte secondary battery, comprising a positive electrode containing a complex oxide of the composition formula LiₓMO₂ or Li_{y} M₂O₄ (wherein, M represents one or more kinds of transition metals, 0≦x≦1, 0≦y≦2), a negative electrode which adsorbs/desorbs lithium, and an electrolyte, wherein

said electrolyte contains LiBF₄ in an amount of not less than 0.01% by mass and not more than 2% by mass relative to the total mass of the electrolyte, an aromatic compound in an amount of not less than 0.1% by mass and not more than 4% by mass relative to the total mass of the electrolyte, and one or more kinds of compounds selected from the group consisting of vinylethylene carbonate, phenylethylene carbonate and cyclic carboxylic anhydrides in an amount of not less than 0.1% by mass and not more than 2% by mass relative to the total mass of the electrolyte.

In the first aspect, deterioration of positive and negative electrodes due to oxidation decomposition of LiFOB or LiBOB can be suppressed and decrease in the charge/discharge cycle life property can be suppressed, because one or more kinds of compounds selected from the group consisting of compound (LiFOB) of the formula (1) and compound (LiBOB) of the formula (2) in an amount of not less than 0.1% by mass and not more than 2% by mass relative to the total mass of the electrolyte, and an aromatic compound in an amount of not less than 0.1% by mass and not more than 4% by mass relative to the total mass of the electrolyte, are contained in the electrolyte. Further, gas generation due to oxidation decomposition of LiFOB or LiBOB can be suppressed, and swelling of a battery when left in high temperature environments can be suppressed.

When LiFOB or LiBOB is added to the electrolyte, the salt is oxidatively decomposed to form a film showing high lithium ion transfer resistance on the surface of a positive electrode active material, leading to significant polarization of a positive electrode. In oxidative decomposition of the salt, oxalic acid or HF is generated in the case of LiFOB or LiBOB, thus, positive electrode active material is decomposed leading to deactivation. A metal ion eluted from a positive electrode active material is reduced on a negative electrode, thereby, a film of high resistance is formed on a negative electrode, thus, decomposition of an electrolyte on a negative electrode is promoted, leading to progress of exhaustion of the electrolyte. Because of such deterioration of positive and negative electrodes due to oxidation decomposition of the salt, a problem of decrease in the charge/discharge cycle life property occurs, however, since an aromatic compound has lower oxidation potential than LiFOB and LiBOB, it acts as an antioxidant for the salt, deterioration of positive and negative electrodes due to oxidation decomposition of the salt can be suppressed, and decrease in the charge/discharge cycle life property can be suppressed.

In the case of addition of LiFOB or LiBOB to the electrolyte, when LiFOB or LiBOB is oxidized on a positive electrode, oxalic acid and HF are generated, and oxalic acid is again oxidized to generate carbon dioxide. By such a gas generation reaction on a positive electrode, a problem of increase in swelling of a battery when left in high temperature environments occurs, however, since an aromatic compound has lower oxidation potential than LiFOB and LiBOB, it acts as an antioxidant for the salt, gas generation due to oxidation decomposition of the salt can be suppressed, and swelling of a battery when left in high temperature environments is suppressed.

While the negative electrode film formed singly of an aromatic compound is unstable, when used in admixture with LiFOB or LiBOB, an aromatic compound and LiFOB or LiBOB coexist, thereby, a stable negative electrode film is formed, thus, when both LiFOB or LiBOB and an aromatic compound are added to an electrolyte, the charge/discharge cycle life property is improved more than the case of addition of only one of them.

When at least one of LiFOB and LiBOB is added in an amount of larger than 2% by mass relative to the total mass of the electrolyte, excess LiFOB or LiBOB in the electrolyte solution reacts with a positive electrode, and causes decrease in the charge/discharge cycle life performance and swelling of a battery when left in high temperature environments, thus, the addition amount thereof is set not larger than 2% by mass. When the addition amount of LiFOB and LiBOB is smaller than 0.1% by mass relative to the total mass of the electrolyte, the effect due to addition of LiFOB and LiBOB is not obtained easily, therefore, the addition amount of LiFOB and LiBOB is set not lower than 0.1% by mass.

When the addition amount of LiFOB and LiBOB is increased, it is necessary to increase also the addition amount of an aromatic compound, to suppress a reaction of LiFOB and LiBOB with a positive electrode. However, if the addition amount of an aromatic compound is larger than 4% by mass relative to the total mass of the electrode, an excess aromatic compound is oxidized on a positive electrode to form a polymerized substance, inducing clogging of a separator, thereby, charge/discharge properties such as charge/discharge cycle life property and the like lower, and hydrogen is generated to cause swelling of a battery when left in high temperature environments; thus, the addition amount of an aromatic compound is set not higher than 4% by mass. When the addition amount of an aromatic compound is smaller than 0.1% by mass relative to the total mass of the electrolyte, the effect due to addition of an aromatic compound is not obtained easily, thus, the addition amount of an aromatic compound is set not less than 0.1% by mass.

In the second aspect, decrease in the charge/discharge cycle life property and swelling of a battery when left in high temperature environments can be suppressed without causing problems on a nonaqueous electrolyte secondary battery, by addition of one or more kinds of aromatic compounds selected from the group consisting of biphenyl, cyclohexylbenzene, 2,4-difluoroanisole, 2-fluorobiphenyl, tertiary amylbenzene, toluene, ethylbenzene, 4-fluorodiphenyl ether and triphenyl phosphate to an electrolyte. When triphenyl phosphate is added, swelling of a battery when left in high temperature environments can be suppressed more successfully than in the case of addition of other compounds.

In the third aspect, a hydrogen gas generated in initial charging can be suppressed and the initial battery thickness can be decreased by inclusion, into an electrolyte, of one or more kinds of compounds selected from the group consisting of vinylene carbonate, vinylethylene carbonate, phenylethylene carbonate and cyclic carboxylic anhydrides in an amount of not less than 0.1% by mass and not more than 2% by mass relative to the total mass of the electrolyte. When the addition amount is larger than 2% by mass, the resistance of a film on a negative electrode increases, irreversible metal lithium deposits on a negative electrode, leading to decrease in initial capacity, thus, the addition amount is set not higher than 2% by mass. When the addition amount is smaller than 0.1% by mass, the effect owing to addition is not obtained easily, thus, the addition amount is set not lower than 0.1% by mass.

In the fourth aspect, by inclusion of LiBF₄ into the electrolyte, electrochemical stability of the electrolyte is high, high electric conductivity is shown in a wider temperature range, and quality of the battery can be improved.

In the fifth aspect, by inclusion of LiBF₄ in an amount of not less than 0.01% by mass and not more than 2% by mass relative to the total mass of the electrolyte, and one or more kinds of compounds hereinafter referred to as compounds (hereinafter referred to as compounds such as biphenyl) selected from the group consisting of biphenyl, 2,4-difluoroanisole, 2-fluorobiphenyl, toluene, ethylbenzene, 4-fluorodiphenyl ether and triphenyl phosphate in an amount of not less than 0.1% by mass and not more than 4% by mass relative to the total mass of the electrolyte, deterioration of positive and negative electrodes due to oxidation decomposition of LiBF₄ can be suppressed and decrease in the charge/discharge cycle life property can be suppressed. Further, gas generation due to oxidation decomposition of LiBF₄ can be suppressed, and swelling of a battery when left in high temperature environments can be suppressed.

When LiBF₄ is added to the electrolyte, the salt is oxidatively decomposed to form a film showing high lithium ion transfer resistance on the surface of a positive electrode active material, leading to significant polarization of a positive electrode. In oxidative decomposition of the salt, since HF is generated, positive electrode active material is decomposed leading to deactivation. A metal ion eluted from a positive electrode active material is reduced on a negative electrode, thereby, a film of high resistance is formed on a negative electrode, thus, decomposition of an electrolyte on a negative electrode is promoted, leading to progress of exhaustion of the electrolyte. Because of such deterioration of positive and negative electrodes due to oxidation decomposition of the salt, a problem of decrease in the charge/discharge cycle life property occurs, however, since compounds such as biphenyl have lower oxidation potential than LiBF₄, it acts as an antioxidant for the salt, deterioration of positive and negative electrodes due to oxidation decomposition of the salt can be suppressed, and decrease in the charge/discharge cycle life property can be suppressed.

When LiBF₄ is oxidized on a positive electrode, HF and a gas BF₃ are generated. Since BF₃ is a very strong Lewis acid, it reacts with carbonates contained in the electrolyte, to generate carbon dioxide, alkanes, alkenes and the like. Such a gas generation reaction on a positive electrode causes a problem of increase in swelling of a battery when left in high temperature environments, however, since compounds such as biphenyl have lower oxidation potential than LiBF₄, it acts as an antioxidant for the salt, gas generation due to oxidation decomposition of the salt can be suppressed, and swelling of a battery when left in high temperature environments is suppressed.

While the negative electrode film formed singly of triphenyl phosphate is unstable, when used in admixture with LiBF₄, a stable negative electrode film is formed, thus, when both LiBF₄ and compounds such as biphenyl are added to an electrolyte, the charge/discharge cycle life property is improved more than the case of addition of only one of them.

When LiBF₄ is added in an amount of larger than 2% by mass relative to the total mass of the electrolyte, excess LiBF₄ in the electrolyte solution reacts with a positive electrode, leading to easy occurrence of decrease in the charge/discharge cycle life property and swelling of a battery when left in high temperature environments, thus, the addition amount thereof is set not larger than 2% by mass. When the addition amount of LiBF₄ is smaller than 0.01% by mass relative to the total mass of the electrolyte, the effect due to addition of LiBF₄ is not obtained easily, therefore, the addition amount of LiBF₄ is set not lower than 0.01% by mass.

When the addition amount of LiBF₄ is increased, it is necessary to increase also the addition amount of compounds such as biphenyl, to suppress a reaction of LiBF₄ with a positive electrode. However, if the addition amount of compounds such as biphenyl is larger than 4% by mass relative to the total mass of the electrode, an excess compounds such as biphenyl is oxidized on a positive electrode to form a polymerized substance, inducing clogging of a separator, thereby, charge/discharge properties such as charge/discharge cycle life property and the like lower, and hydrogen is generated to cause swelling of a battery when left in high temperature environments, thus, the addition amount of compounds such as biphenyl is set not higher than 4% by mass. When the addition amount of compounds such as biphenyl is smaller than 0.1% by mass relative to the total mass of the electrolyte, the effect due to addition of compounds such as biphenyl is not obtained easily, thus, the addition amount of compounds such as biphenyl is set not less than 0.1% by mass.

In the sixth aspect, by inclusion, into an electrolyte, of one or more kinds of compounds selected from the group consisting of vinylene carbonate, vinylethylethylene carbonate, phenylethylene carbonate and cyclic carboxylic anhydrides in an amount of not less than 0.1% by mass and not more than 2% by mass relative to the total mass of the electrolyte, a hydrogen gas generated in initial charging can be suppressed and the initial battery thickness can be decreased. When the addition amount is larger than 2% by mass, the resistance of a film on a negative electrode increases, irreversible metal lithium deposits on a negative electrode, leading to decrease in initial capacity, thus, the addition amount is set not higher than 2% by mass. When the addition amount is smaller than 0.1% by mass, the effect owing to addition is not obtained easily, thus, the addition amount is set not lower than 0.1% by mass.

In the seventh aspect, by inclusion of LiBF₄ in an amount of not less than 0.01% by mass and not more than 2% by mass relative to the total mass of the electrolyte, an aromatic compound in an amount of not less than 0.1% by mass and not more than 4% by mass relative to the total mass of the electrolyte, and one or more kinds of compounds selected from the group consisting of vinylethylene carbonate, phenylethylene carbonate and cyclic carboxylic anhydrides in an amount of not less than 0.1% by mass and not more than 2% by mass relative to the total mass of the electrolyte, similar to the above-described fifth and sixth aspects, deterioration of positive and negative electrodes due to oxidation decomposition of LiBF₄ can be suppressed and decrease in the charge/discharge cycle life property can be suppressed. Further, gas generation due to oxidation decomposition of LiBF₄ can be suppressed, and swelling of a battery when left in high temperature environments can be suppressed.

According to the first aspect, decrease in the charge/discharge cycle life property and swelling of a battery when left in high temperature environments can be suppressed.

According to the second aspect, decrease in the charge/discharge cycle life property and swelling of a battery when left in high temperature environments can be suppressed without causing problems on a nonaqueous electrolyte secondary battery.

According to the third aspect, the initial battery thickness can be decreased.

According to the fourth aspect, electrochemical stability of the electrolyte can be heightened.

According to the fifth aspect, decrease in the charge/discharge cycle life property and swelling of a battery when left in high temperature environments can be suppressed.

According to the sixth aspect, the initial battery thickness can be decreased.

According to the seventh aspect, decrease in the charge/discharge cycle life property and swelling of a battery when left in high temperature environments can be suppressed, and the initial battery thickness can be decreased.

### BRIEF DESCRIPTION OF THE DRAWINGS

FIG. 1 is a sectional view showing an example of the constitution of a nonaqueous electrolyte secondary battery according to the present invention;

FIG. 2 is a table showing the measurement results of the capacity retention, thickness increase and recovery ratio of the batteries obtained by adding LiBF₄ to the electrolytic solution;

FIG. 3 are tables showing the measurement results partially extracted from FIG. 2 and rearranged;

FIG. 4 is a table showing the measurement results of the initial capacity, initial battery thickness, capacity retention, thickness increase and recovery ratio of the batteries obtained by adding LiBF₄ to the electrolytic solution;

FIG. 5 is a table showing the measurement results of the initial capacity, initial battery thickness, capacity retention, thickness increase and recovery ratio of the batteries obtained by adding LiBF₄ to the electrolytic solution;

FIG. 6 is a table showing the measurement results of the initial capacity, initial battery thickness, capacity retention, thickness increase and recovery ratio of the batteries obtained by adding LiBF₄ to the electrolytic solution;

FIG. 7 is a table showing the measurement results of the initial capacity, initial battery thickness, capacity retention, thickness increase and recovery ratio of the batteries obtained by adding LiBF₄ to the electrolytic solution;

FIG. 8 is a table showing the measurement results of the capacity retention, thickness increase and recovery ratio of the batteries obtained by adding LiFOB to the electrolytic solution;

FIG. 9 are tables showing the measurement results partially extracted from FIG. 8 and rearranged;

FIG. 10 is a table showing the measurement results of the initial capacity, initial battery thickness, capacity retention, thickness increase and recovery ratio of the batteries obtained by adding LiFOB to the electrolytic solution;

FIG. 11 is a table showing the measurement results of the initial capacity, initial battery thickness, capacity retention, thickness increase and recovery ratio of the batteries obtained by adding LiFOB to the electrolytic solution;

FIG. 12 is a table showing the measurement results of the initial capacity, initial battery thickness, capacity retention, thickness increase and recovery ratio of the batteries obtained by adding LiFOB to the electrolytic solution;

FIG. 13 is a table showing the measurement results of the initial capacity, initial battery thickness, capacity retention, thickness increase and recovery ratio of the batteries obtained by adding LiFOB to the electrolytic solution;

FIG. 14 is a table showing the measurement results of the capacity retention, thickness increase and recovery ratio of the batteries obtained by adding LiBOB to the electrolytic solution;

FIG. 15 are tables showing the measurement results partially extracted from FIG. 14 and rearranged;

FIG. 16 is a table showing the measurement results of the initial capacity, initial battery thickness, capacity retention, thickness increase and recovery ratio of the batteries obtained by adding LiBOB to the electrolytic solution;

FIG. 17 is a table showing the measurement results of the initial capacity, initial battery thickness, capacity retention, thickness increase and recovery ratio of the batteries obtained by adding LiBOB to the electrolytic solution;

FIG. 18 is a table showing the measurement results of the initial capacity, initial battery thickness, capacity retention, thickness increase and recovery ratio of the batteries obtained by adding LiBOB to the electrolytic solution; and

FIG. 19 is a table showing the measurement results of the initial capacity, initial battery thickness, capacity retention, thickness increase and recovery ratio of the batteries obtained by adding LiBOB to the electrolytic solution.

### EXPLANATION OF CODES

1: battery
2: electrode group
3: negative electrode
4: positive electrode
5: separator
6: battery case
7: battery cap
8: safety valve
9: negative electrode terminal
10: negative electrode lead

### BEST MODES FOR CARRYING OUT THE INVENTION

The present invention will be illustrated using suitable examples, but is not limited to these examples at all, and can be carried out with suitable modifications in a range not deviating from its major subject.

### Examples 1

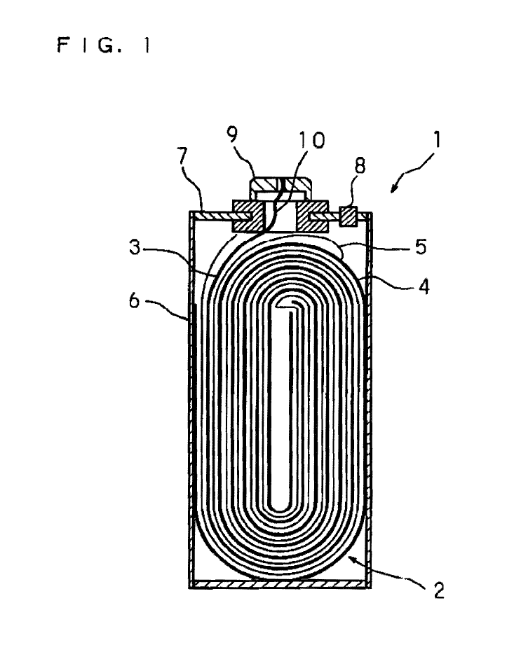

FIG. 1 is a sectional view showing an example of the constitution of a nonaqueous electrolyte secondary battery according to the present invention. In FIG. 1, 1 represents a nonaqueous electrolyte secondary battery of rectangular shape (hereinafter, referred to as battery), 2 represents an electrode group, 3 represents a negative electrode, 4 represents a positive electrode, 5 represents a separator, 6 represents a battery case, 7 represents a battery cap, 8 represents a safety valve, 9 represents a negative electrode terminal, and 10 represents a negative electrode lead. The electrode group 2 is obtained by winding the negative electrode 3 and the positive electrode 4 in the form of flat via the separator 5. The electrode group 2 and electrolytic solution (electrolyte) are accommodated in the battery case 6, and an opening of the battery case 6 is sealed by laser-welding the battery cap 7 equipped with the safety valve 8. The negative electrode terminal 9 is connected to the negative electrode 3 via the negative electrode lead 10, and the positive electrode 4 is connected to the inner surface of the battery case 6.

The positive electrode 4 is manufactured as follows: 90% by weight of LiCoO₂ as an active material, 5% by weight of acetylene black as a conductive auxiliary and 5% by weight of polyvinylidene fluoride as a binder are mixed to give a positive electrode combination agent which is dispersed in N-methyl-2-pyrrolidone to prepare a paste, and the prepared paste is applied uniformly on an aluminum collector having a thickness of 20 μm and dried, then, compression-molded by a roll press.

The negative electrode 3 is manufactured as follows: 95% by weight of graphite as a negative electrode active material, 3% by weight of carboxymethylcellulose as a binder and 2% by weight of styrene butadiene rubber are mixed, distilled water is added appropriately to disperse the mixture preparing a slurry, and the prepared slurry is applied uniformly and dried on a copper collector having a thickness of 15 μm, and dried at 100° C. for 5 hours, then, compression-molded by a roll press so that the density of the negative electrode active material layer made of the binder and active material is 1.40 g/cm³.

As the separator, a fine porous polyethylene film having a thickness of 20 μm is used. Used as the electrolytic solution (electrolyte) is one that is prepared by dissolving LiPF₆ at a proportion of 1.1 mol/L in a mixed solvent of ethylene carbonate (EC) and ethyl methyl carbonate (EMC) of a volume ratio of 3:7, and further adding 0.01% by mass of LiBF₄ and 0.1% by mass of biphenyl (BP) relative to the total mass of the electrolytic solution. The designed capacity of the battery is 600 mAh.

### Example 2

A battery is manufactured in the same manner as in Example 1 excepting that the amount of BP to be added to the electrolytic solution is 0.5% by mass.

### Example 3

A battery is manufactured in the same manner as in Example 1 excepting that the amount of BP to be added to the electrolytic solution is 4% by mass.

### Example 4

A battery is manufactured in the same manner as in Example 1 excepting that the amount of LiBF₄ and the amount of BP to be added to the electrolytic solution are 0.05% by mass and 0.5% by mass respectively.

### Example 5

A battery is manufactured in the same manner as in Example 1 excepting that the amount of LiBF₄ and the amount of BP to be added to the electrolytic solution are 0.1% by mass and 0.2% by mass respectively.

### Example 6

A battery is manufactured in the same manner as in Example 1 excepting that the amount of LiBF₄ and the amount of BP to be added to the electrolytic solution are 0.1% by mass and 0.5% by mass respectively.

### Example 7

A battery is manufactured in the same manner as in Example 1 excepting that the amount of LiBF₄ and the amount of BP to be added to the electrolytic solution are 0.1% by mass and 1% by mass respectively.

### Example 8

A battery is manufactured in the same manner as in Example 1 excepting that the amount of LiBF₄ and the amount of BP to be added to the electrolytic solution are 0.2% by mass and 0.1% by mass respectively.

### Example 9

A battery is manufactured in the same manner as in Example 1 excepting that the amount of LiBF₄ and the amount of BP to be added to the electrolytic solution are 0.2% by mass and 0.2% by mass respectively.

### Example 10

A battery is manufactured in the same manner as in Example 1 excepting that the amount of LiBF₄ and the amount of BP to be added to the electrolytic solution are 0.2% by mass and 0.5% by mass respectively.

### Example 11

A battery is manufactured in the same manner as in Example 1 excepting that the amount of LiBF₄ and the amount of BP to be added to the electrolytic solution are 0.2% by mass and 1% by mass respectively.

### Example 12

A battery is manufactured in the same manner as in Example 1 excepting that the amount of LiBF₄ and the amount of BP to be added to the electrolytic solution are 0.2% by mass and 2% by mass respectively.

### Example 13

A battery is manufactured in the same manner as in Example 1 excepting that the amount of LiBF₄ and the amount of BP to be added to the electrolytic solution are 0.2% by mass and 4% by mass respectively.

### Example 14

A battery is manufactured in the same manner as in Example 1 excepting that the amount of LiBF₄ and the amount of BP to be added to the electrolytic solution are 0.5% by mass and 0.2% by mass respectively.

### Example 15

A battery is manufactured in the same manner as in Example 1 excepting that the amount of LiBF₄ and the amount of BP to be added to the electrolytic solution are 0.5% by mass and 0.5% by mass respectively.

### Example 16

A battery is manufactured in the same manner as in Example 1 excepting that the amount of LiBF₄ and the amount of BP to be added to the electrolytic solution are 0.5% by mass and 1% by mass respectively.

### Example 17

A battery is manufactured in the same manner as in Example 1 excepting that the amount of LiBF₄ and the amount of BP to be added to the electrolytic solution are 2% by mass and 0.1% by mass respectively.

### Example 18

A battery is manufactured in the same manner as in Example 1 excepting that the amount of LiBF₄ and the amount of BP to be added to the electrolytic solution are 2% by mass and 0.5% by mass respectively.

### Example 19

A battery is manufactured in the same manner as in Example 1 excepting that the amount of LiBF₄ and the amount of BP to be added to the electrolytic solution are 2% by mass and 4% by mass respectively.

### Example 20

A battery is manufactured in the same manner as in Example 10 excepting that 0.1% by mass of vinylene carbonate (VC) is further added relative to the total mass of the electrolytic solution.

### Example 21

A battery is manufactured in the same manner as in Example 10 excepting that 0.5% by mass of VC is further added relative to the total mass of the electrolytic solution.

### Example 22

A battery is manufactured in the same manner as in Example 10 excepting that 1.0% by mass of VC is further added relative to the total mass of the electrolytic solution.

### Example 23

A battery is manufactured in the same manner as in Example 10 excepting that 1.5% by mass of VC is further added relative to the total mass of the electrolytic solution.

### Example 24

A battery is manufactured in the same manner as in Example 10 excepting that 2.0% by mass of VC is further added relative to the total mass of the electrolytic solution.

### Example 25

A battery is manufactured in the same manner as in Example 10 excepting that 1.0% by mass of vinylethylene carbonate (VEC) is further added relative to the total mass of the electrolytic solution.

### Example 26

A battery is manufactured in the same manner as in Example 10 excepting that 0.5% by mass of VC and 0.5% by mass of VEC are further added relative to the total mass of the electrolytic solution.

### Example 27

A battery is manufactured in the same manner as in Example 10 excepting that 1.0% by mass of phenylethylene carbonate (PhEC) is further added relative to the total mass of the electrolytic solution.

### Example 28

A battery is manufactured in the same manner as in Example 10 excepting that 1.0% by mass of succinic anhydride is further added relative to the total mass of the electrolytic solution.

### Example 29

A battery is manufactured in the same manner as in Example 11 excepting that 1.0% by mass of cyclohexylbenzene (CHB) is added to the electrolytic solution instead of 1.0% by mass of biphenyl (BP).

### Example 30

A battery is manufactured in the same manner as in Example 11 excepting that 1.0% by mass of 2,4-difluoroanisole (2,4 FA) is added to the electrolytic solution instead of 1.0% by mass of BP.

### Example 31

A battery is manufactured in the same manner as in Example 11 excepting that 1.0% by mass of 2-fluorobiphenyl (2 FBP) is added to the electrolytic solution instead of 1.0% by mass of BP.

### Example 32

A battery is manufactured in the same manner as in Example 11 excepting that 1.0% by mass of tertiary amyl benzene (TAB) is added to the electrolytic solution instead of 1.0% by mass of BP.

### Example 33

A battery is manufactured in the same manner as in Example 11 excepting that 1.0% by mass of toluene (TOL) is added to the electrolytic solution instead of 1.0% by mass of BP.

### Example 34

A battery is manufactured in the same manner as in Example 11 excepting that 1.0% by mass of ethylbenzene (EB) is added to the electrolytic solution instead of 1.0% by mass of BP.

### Example 35

A battery is manufactured in the same manner as in Example 11 excepting that 1.0% by mass of 4-fluorodiphenyl ether (4 FDPE) is added to the electrolytic solution instead of 1.0% by mass of BP.

### Example 36

A battery is manufactured in the same manner as in Example 11 excepting that 1.0% by mass of triphenyl phosphate (TPP) is added to the electrolytic solution instead of 1.0% by mass of BP.

### Example 37

A battery is manufactured in the same manner as in Example 22 excepting that 0.5% by mass of CHB is added to the electrolytic solution instead of 0.5% by mass of BP.

### Example 38

A battery is manufactured in the same manner as in Example 22 excepting that 0.5% by mass of 2,4FA is added to the electrolytic solution instead of 0.5% by mass of BP.

### Example 39

A battery is manufactured in the same manner as in Example 22 excepting that 0.5% by mass of 2FBP is added to the electrolytic solution instead of 0.5% by mass of BP.

### Example 40

A battery is manufactured in the same manner as in Example 22 excepting that 0.5% by mass of TAB is added to the electrolytic solution instead of 0.5% by mass of BP.

### Example 41

A battery is manufactured in the same manner as in Example 22 excepting that 0.5% by mass of TOL is added to the electrolytic solution instead of 0.5% by mass of BP.

### Example 42

A battery is manufactured in the same manner as in Example 22 excepting that 0.5% by mass of EB is added to the electrolytic solution instead of 0.5% by mass of BP.

### Example 43

A battery is manufactured in the same manner as in Example 22 excepting that 0.5% by mass of 4FDPE is added to the electrolytic solution instead of 0.5% by mass of BP.

### Example 44

A battery is manufactured in the same manner as in Example 22 excepting that 0.5% by mass of TPP is added to the electrolytic solution instead of 0.5% by mass of BP.

### Example 45

A battery is manufacture is manufactured in the same manner as in Example 22 excepting that a mixed solvent of ethylene carbonate (EC) and diethylene carbonate (DEC) of a volume ratio of 3:7 is used as a solvent for the electrolytic solution instead of a mixed solvent of EC and ethyl methyl carbonate (EMC) of a volume ratio of 3:7.

### Example 46

A battery is manufactured in the same manner as in Example 22 excepting that a mixed solvent of EC and dimethyl carbonate (DMC) of a volume ratio of 3:7 is used as a solvent for the electrolytic solution instead of a mixed solvent of EC and EMC of a volume ratio of 3:7.

### Example 47

A battery is manufactured in the same manner as in Example 22 excepting that a mixed solvent of EC and EMC and DEC of a volume ratio of 3:5:2 is used as a solvent for the electrolytic solution instead of a mixed solvent of EC and EMC of a volume ratio of 3:7.

### Example 48

A battery is manufactured in the same manner as in Example 22 excepting that the amount of dissolution of LiPF₆ in the electrolytic solution is changed from 1.1 mol/L to 1.5 mol/L.

### Example 49

A battery is manufactured in the same manner as in Example 22 excepting that the amount of dissolution of LiPF₆ in the electrolytic solution is changed from 1.1 mol/L to 0.7 mol/L.

### Example 50

A battery is manufactured in the same manner as in Example 22 excepting that a mixed solvent of EC and propylene carbonate (PC) and EMC of a volume ratio of 2:1:7 is used as a solvent for the electrolytic solution instead of a mixed solvent of EC and EMC of a volume ratio of 3:7.

### Example 51

A battery is manufactured in the same manner as in Example 22 excepting that LiNiO₂ is used as the positive electrode active material instead of LiCoO₂.

### Example 52

A battery is manufactured in the same manner as in Example 22 excepting that LiMn₂O₄ is used as the positive electrode active material instead of LiCoO₂.

### Example 53

A battery is manufactured in the same manner as in Example 22 excepting that LiNi_{0.4}Co_{0.3}Mn_{0.3}O₂ is used as the positive electrode active material instead of LiCoO₂.

### Example 54

A battery is manufactured in the same manner as in Example 1 excepting that the amount of biphenyl (BP) to be added to the electrolytic solution is 0.1% by mass and 0.1% by mass of a compound (LiFOB) represented by the formula I is added to the electrolytic solution instead of LiBF₄.

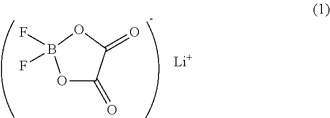

### Example 55

A battery is manufactured in the same manner as in Example 54 excepting that the amount of BP to be added to the electrolytic solution is 1% by mass.

### Example 56

A battery is manufactured in the same manner as in Example 54 excepting that the amount of BP to be added to the electrolytic solution is 4% by mass.

### Example 57

A battery is manufactured in the same manner as in Example 54 excepting that the amount of LiFOB and the amount of BP to be added to the electrolytic solution are 0.5% by mass and 0.5% by mass respectively.

### Example 58

A battery is manufactured in the same manner as in Example 54 excepting that the amount of LiFOB and the amount of BP to be added to the electrolytic solution are 0.5% by mass and 1% by mass respectively.

### Example 59

A battery is manufactured in the same manner as in Example 54 excepting that the amount of LiFOB and the amount of BP to be added to the electrolytic solution are 0.5% by mass and 2% by mass respectively.

### Example 60

A battery is manufactured in the same manner as in Example 54 excepting that the amount of LiFOB and the amount of BP to be added to the electrolytic solution are 1% by mass and 0.1% by mass respectively.

### Example 61

A battery is manufactured in the same manner as in Example 54 excepting that the amount of LiFOB and the amount of BP to be added to the electrolytic solution are 1% by mass and 0.5% by mass respectively.

### Example 62

A battery is manufactured in the same manner as in Example 54 excepting that the amount of LiFOB and the amount of BP to be added to the electrolytic solution are 1% by mass and 1% by mass respectively.

### Example 63

A battery is manufactured in the same manner as in. Example 54 excepting that the amount of LiFOB and the amount of BP to be added to the electrolytic solution are 1% by mass and 2% by mass respectively.

### Example 64

A battery is manufactured in the same manner as in Example 54 excepting that the amount of LiFOB and the amount of BP to be added to the electrolytic solution are 1% by mass and 4% by mass respectively.

### Example 65

A battery is manufactured in the same manner as in Example 54 excepting that the amount of LiFOB and the amount of BP to be added to the electrolytic solution are 1.5% by mass and 0.5% by mass respectively.

### Example 66

A battery is manufactured in the same manner as in Example 54 excepting that the amount of LiFOB and the amount of BP to be added to the electrolytic solution are 1.5% by mass and 1% by mass respectively.

### Example 67

A battery is manufactured in the same manner as in Example 54 excepting that the amount of LiFOB and the amount of BP to be added to the electrolytic solution are 1.5% by mass and 2% by mass respectively.

### Example 68

A battery is manufactured in the same manner as in Example 54 excepting that the amount of LiFOB and the amount of BP to be added to the electrolytic solution are 2% by mass and 0.1% by mass respectively.

### Example 69

A battery is manufactured in the same manner as in Example 54 excepting that the amount of LiFOB and the amount of BP to be added to the electrolytic solution are 2% by mass and 1% by mass respectively.

### Example 70

A battery is manufactured in the same manner as in Example 54 excepting that the amount of LiFOB and the amount of BP to be added to the electrolytic solution are 2% by mass and 4% by mass respectively.

### Example 71

A battery is manufactured in the same manner as in Example 62 excepting that 0.1% by mass of vinylene carbonate (VC) is further added relative to the total mass of the electrolytic solution.

### Example 72

A battery is manufactured in the same manner as in Example 62 excepting that 0.5% by mass of VC is further added relative to the total mass of the electrolytic solution.

### Example 73

A battery is manufactured in the same manner as in Example 62 excepting that 1.0% by mass of VC is further added relative to the total mass of the electrolytic solution.

### Example 74

A battery is manufactured in the same manner as in Example 62 excepting that 2.0% by mass of VC is further added relative to the total mass of the electrolytic solution.

### Example 75

A battery is manufactured in the same manner as in Example 62 excepting that 1.0% by mass of vinylethylene carbonate (VEC) is further added relative to the total mass of the electrolytic solution.

### Example 76

A battery is manufactured in the same manner as in Example 62 excepting that 0.5% by mass of VC and 0.5% by mass of VEC are further added relative to the total mass of the electrolytic solution.

### Example 77

A battery is manufactured in the same manner as in Example 62 excepting that 1.0% by mass of phenylethylene carbonate (PhEC) is further added relative to the total mass of the electrolytic solution.

### Example 78

A battery is manufactured in the same manner as in Example 62 excepting that 1.0% by mass of succinic anhydride is further added relative to the total mass of the electrolytic solution.

### Example 79

A battery is manufactured in the same manner as in Example 62 excepting that 1% by mass of cyclohexylbenzene (CHB) is added to the electrolytic solution instead of 1% by mass of biphenyl (BP).

### Example 80

A battery is manufactured in the same manner as in Example 62 excepting that 1% by mass of 2,4-difluoroanisole (2,4FA) is added to the electrolytic solution instead of 1% by mass of BP.

### Example 81

A battery is manufactured in the same manner as in Example 62 excepting that 1% by mass of 2-fluorobiphenyl (2FBP) is added to the electrolytic solution instead of 1% by mass of BP.

### Example 82

A battery is manufactured in the same manner as in Example 62 excepting that 1% by mass of tertiary amylbenzene (TAB) is added to the electrolytic solution instead of 1% by mass of BP.

### Example 83

A battery is manufactured in the same manner as in Example 62 excepting that 1% by mass of toluene (TOL) is added to the electrolytic solution instead of 1% by mass of BP.

### Example 84

A battery is manufactured in the same manner as in Example 62 excepting that 1% by mass of ethylbenzene (EB) is added to the electrolytic solution instead of 1% by mass of BP.

### Example 85

A battery is manufactured in the same manner as in Example 62 excepting that 1% by mass of 4° fluorodiphenyl ether (4FDPE) is added to the electrolytic solution instead of 1% by mass of BP.

### Example 86

A battery is manufactured in the same manner as in Example 62 excepting that 1% by mass of triphenyl phosphate (TPP) is added to the electrolytic solution instead of 1% by mass of BP.

### Example 87

A battery is manufactured in the same manner as in Example 73 excepting that 1% by mass of CHB is added to the electrolytic solution instead of 1% by mass of BP.

### Example 88

A battery is manufactured in the same manner as in Example 73 excepting that 1% by mass of 2,4FA is added to the electrolytic solution instead of 1% by mass of BP.

### Example 89

A battery is manufactured in the same manner as in Example 73 excepting that 1% by mass of 2FBP is added to the electrolytic solution instead of 1% by mass of BP.

### Example 90

A battery is manufactured in the same manner as in Example 73 excepting that 1% by mass of TAB is added to the electrolytic solution instead of 1% by mass of BP.

### Example 91

A battery is manufactured in the same manner as in Example 73 excepting that 1% by mass of TOL is added to the electrolytic solution instead of 1% by mass of BP.

### Example 92

A battery is manufactured in the same manner as in Example 73 excepting that 1% by mass of EB is added to the electrolytic solution instead of 1% by mass of BP.

### Example 93

A battery is manufactured in the same manner as in Example 73 excepting that 1% by mass of 4FDPE is added to the electrolytic solution instead of 1% by mass of BP.

### Example 94

A battery is manufactured in the same manner as in Example 73 excepting that 1% by mass of TPP is added to the electrolytic solution instead of 1% by mass of BP.

### Example 95

A battery is manufactured in the same manner as in Example 73 excepting that a mixed solvent of ethylene carbonate (EC) and diethylene carbonate (DEC) of a volume ratio of 3:7 is used as a solvent for the electrolytic solution instead of a mixed solvent of EC and ethyl methyl carbonate (EMC) of a volume ratio of 3:7.

### Example 96

A battery is manufactured in the same manner as in Example 73 excepting that a mixed solvent of EC and dimethyl carbonate (DMC) of a volume ratio of 3:7 is used as a solvent for the electrolytic solution instead of a mixed solvent of EC and EMC of a volume ratio of 3:7.

### Example 97

A battery is manufactured in the same manner as in Example 73 excepting that a mixed solvent of EC and EMC and DEC of a volume ratio of 3:5:2 is used as a solvent for the electrolytic solution instead of a mixed solvent of EC and EMC of a volume ratio of 3:7.

### Example 98

A battery is manufactured in the same manner as in Example 73 excepting that the amount of dissolution of LiPF₆ in the electrolytic solution is changed from 1.1 mol/L to 1.5 mol/L.

### Example 99

A battery is manufactured in the same manner as in Example 73 excepting that the amount of dissolution of LiPF₆ in the electrolytic solution is changed from 1.1 mol/L to 0.7 mol/L.

### Example 100

A battery is manufactured in the same manner as in Example 73 excepting that a mixed solvent of EC and propylene carbonate (PC) and EMC of a volume ratio of 2:1:7 is used as a solvent for the electrolytic solution instead of a mixed solvent of EC and EMC of a volume ratio of 3:7.

### Example 101

A battery is manufactured in the same manner as in Example 73 excepting that LiNiO₂ is used as the positive electrode active material instead of LiCoO₂.

### Example 102

A battery is manufactured in the same manner as in Example 73 excepting that LiMn₂O₄ is used as the positive electrode active material instead of LiCoO₂.

### Example 103

A battery is manufactured in the same manner as in Example 73 excepting that LiNi_{0.4}Co_{0.3}Mn_{0.3}O₂ is used as the positive electrode active material instead of LiCoO₂.

### Example 104

A battery is manufactured in the same manner as in Example 1 excepting that the amount of biphenyl (BP) to be added to the electrolytic solution is 0.1% by mass and 0.1% by mass of LiBOB represented by the formula 2 is added to the electrolytic solution instead of LiBF₄.

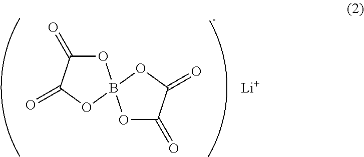

### Example 105

A battery is manufactured in the same manner as in Example 104 excepting that the amount of BP to be added to the electrolytic solution is 1% by mass.

### Example 106

A battery is manufactured in the same manner as in Example 104 excepting that the amount of BP to be added to the electrolytic solution is 4% by mass.

### Example 107

A battery is manufactured in the same manner as in Example 104 excepting that the amount of LiBOB and the amount of BP to be added to the electrolytic solution are 0.5% by mass and 0.5% by mass respectively.

### Example 108

A battery is manufactured in the same manner as in Example 104 excepting that the amount of LiBOB and the amount of BP to be added to the electrolytic solution are 0.5% by mass and 1% by mass respectively.

### Example 109

A battery is manufactured in the same manner as in Example 104 excepting that the amount of LiBOB and the amount of BP to be added to the electrolytic solution are 0.5% by mass and 2% by mass respectively.

### Example 110

A battery is manufactured in the same manner as in Example 104 excepting that the amount of LiBOB and the amount of BP to be added to the electrolytic solution are 1% by mass and 0.1% by mass respectively.

### Example 111

A battery is manufactured in the same manner as in Example 104 excepting that the amount of LiBOB and the amount of BP to be added to the electrolytic solution are 1% by mass and 0.5% by mass respectively.

### Example 112

A battery is manufactured in the same manner as in Example 104 excepting that the amount of LiBOB and the amount of BP to be added to the electrolytic solution are 1% by mass and 1% by mass respectively.

### Example 113

A battery is manufactured in the same manner as in Example 104 excepting that the amount of LiBOB and the amount of BP to be added to the electrolytic solution are 1% by mass and 2% by mass respectively.

### Example 114

A battery is manufactured in the same manner as in Example 104 excepting that the amount of LiBOB and the amount of BP to be added to the electrolytic solution are 1% by mass and 4% by mass respectively.

### Example 115

A battery is manufactured in the same manner as in Example 104 excepting that the amount of LiBOB and the amount of BP to be added to the electrolytic solution are 1.5% by mass and 0.5% by mass respectively.

### Example 116

A battery is manufactured in the same manner as in Example 104 excepting that the amount of LiBOB and the amount of BP to be added to the electrolytic solution are 1.5% by mass and 1% by mass respectively.

### Example 117

A battery is manufactured in the same manner as in Example 104 excepting that the amount of LiBOB and the amount of BP to be added to the electrolytic solution are 1.5% by mass and 2% by mass respectively.

### Example 118

A battery is manufactured in the same manner as in Example 104 excepting that the amount of LiBOB and the amount of BP to be added to the electrolytic solution are 2% by mass and 0.1% by mass respectively.

### Example 119

A battery is manufactured in the same manner as in Example 104 excepting that the amount of LiBOB and the amount of BP to be added to the electrolytic solution are 2% by mass and 1% by mass respectively.

### Example 120

A battery is manufactured in the same manner as in Example 104 excepting that the amount of LiBOB and the amount of BP to be added to the electrolytic solution are 2% by mass and 4% by mass respectively.

### Example 121

A battery is manufactured in the same manner as in Example 112 excepting that 0.1% by mass of vinylene carbonate (VC) is further added relative to the total mass of the electrolytic solution.

### Example 122

A battery is manufactured in the same manner as in Example 112 excepting that 0.5% by mass of VC is further added relative to the total mass of the electrolytic solution.

### Example 123

A battery is manufactured in the same manner as in Example 112 excepting that 1.0% by mass of VC is further added relative to the total mass of the electrolytic solution.

### Example 124

A battery is manufactured in the same manner as in Example 112 excepting that 2.0% by mass of VC is further added relative to the total mass of the electrolytic solution.

### Example 125

A battery is manufactured in the same manner as in Example 112 excepting that 1.0% by mass of vinylethylene carbonate (VEC) is further added relative to the total mass of the electrolytic solution.

### Example 126

A battery is manufactured in the same manner as in Example 112 excepting that 0.5% by mass of VC and 0.5% by mass of VEC are further added relative to the total mass of the electrolytic solution.

### Example 127

A battery is manufactured in the same manner as in Example 112 excepting that 1.0% by mass of phenylethylene carbonate (PhEC) is further added relative to the total mass of the electrolytic solution.

### Example 128

A battery is manufactured in the same manner as in Example 112 excepting that 1.0% by mass of succinic anhydride is further added relative to the total mass of the electrolytic solution.

### Example 129

A battery is manufactured in the same manner as in Example 112 excepting that 1% by mass of cyclohexylbenzene (CHB) is added to the electrolytic solution instead of 1% by mass of biphenyl (BP).

### Example 130

A battery is manufactured in the same manner as in Example 112 excepting that 1% by mass of 2,4-difluoroanisole (2,4FA) is added to the electrolytic solution instead of 1% by mass of BP.

### Example 131

A battery is manufactured in the same manner as in Example 112 excepting that 1% by mass of 2-fluorobiphenyl (2FBP) is added to the electrolytic solution instead of 1% by mass of BP.

### Example 132

A battery is manufactured in the same manner as in Example 112 excepting that 1% by mass of tertiary amylbenzene (TAB) is added to the electrolytic solution instead of 1% by mass of BP.

### Example 133

A battery is manufactured in the same manner as in Example 112 excepting that 1% by mass of toluene (TOL) is added to the electrolytic solution instead of 1% by mass of BP.

### Example 134

A battery is manufactured in the same manner as in Example 112 excepting that 1% by mass of ethylbenzene (EB) is added to the electrolytic solution instead of 1% by mass of BP.

### Example 135

A battery is manufactured in the same manner as in Example 112 excepting that 1% by mass of 4-fluorodiphenyl ether (4FDPE) is added to the electrolytic solution instead of 1% by mass of BP.

### Example 136

A battery is manufactured in the same manner as in Example 112 excepting that 1% by mass of triphenyl phosphate (TPP) is added to the electrolytic solution instead of 1% by mass of BP.

### Example 137

A battery is manufactured in the same manner as in Example 123 excepting that 1% by mass of CHB is added to the electrolytic solution instead of 1% by mass of BP.

### Example 138

A battery is manufactured in the same manner as in Example 123 excepting that 1% by mass of 2,4FA is added to the electrolytic solution instead of 1% by mass of BP.

### Example 139

A battery is manufactured in the same manner as in Example 123 excepting that 1% by mass of 2FBP is added to the electrolytic solution instead of 1% by mass of BP.

### Example 140

A battery is manufactured in the same manner as in Example 123 excepting that 1% by mass of TAB is added to the electrolytic solution instead of 1% by mass of BP.

### Example 141

A battery is manufactured in the same manner as in Example 123 excepting that 1% by mass of TOL is added to the electrolytic solution instead of 1% by mass of BP.

### Example 142

A battery is manufactured in the same manner as in Example 123 excepting that 1% by mass of EB is added to the electrolytic solution instead of 1% by mass of BP.

### Example 143

A battery is manufactured in the same manner as in Example 123 excepting that 1% by mass of 4FDPE is added to the electrolytic solution instead of 1% by mass of BP.

### Example 144

A battery is manufactured in the same manner as in Example 123 excepting that 1% by mass of TPP is added to the electrolytic solution instead of 1% by mass of BP.

### Example 145

A battery is manufactured in the same manner as in Example 123 excepting that a mixed solvent of ethylene carbonate (EC) and diethylene carbonate (DEC) of a volume ratio of 3:7 is used as a solvent for the electrolytic solution instead of a mixed solvent of EC and ethyl methyl carbonate (EMC) of a volume ratio of 3:7.

### Example 146

A battery is manufactured in the same manner as in Example 123 excepting that a mixed solvent of EC and dimethyl carbonate (DMC) of a volume ratio of 3:7 is used as a solvent for the electrolytic solution instead of a mixed solvent of EC and EMC of a volume ratio of 3:7.

### Example 147

A battery is manufactured in the same manner as in Example 123 excepting that a mixed solvent of EC and EMC and DEC of a volume ratio of 3:5:2 is used as a solvent for the electrolytic solution instead of a mixed solvent of EC and EMC of a volume ratio of 3:7.

### Example 148

A battery is manufactured in the same manner as in Example 123 excepting that the amount of dissolution of LiPF₆ in the electrolytic solution is changed from 1.1 mol/L to 15 mol/L.

### Example 149

A battery is manufactured in the same manner as in Example 123 excepting that the amount of dissolution of LiPF₆ in the electrolytic solution is changed from 1.1 mol/L to 0.7 mol/L.

### Example 150

A battery is manufactured in the same manner as in Example 123 excepting that a mixed solvent of EC and propylene carbonate (PC) and EMC of a volume ratio of 2:1:7 is used as a solvent for the electrolytic solution instead of a mixed solvent of EC and EMC of a volume ratio of 3:7.

### Example 151

A battery is manufactured in the same manner as in Example 123 excepting that LiNiO₂ is used as the positive electrode active material instead of LiCoO₂.

### Example 152

A battery is manufactured in the same manner as in Example 123 excepting that LiMn₂O₄ is used as the positive electrode active material instead of LiCoO₂.

### Example 153

A battery is manufactured in the same manner as in Example 123 excepting that LiNi_{0.4}Co_{0.3}Mn_{0.3}O₂ is used as the positive electrode active material instead of LiCoO₂.

### Comparative Example 1

A battery is manufactured in the same manner as in Example 1 excepting that addition of LiBF₄ and biphenyl (BP) to the electrolytic solution is not carried out.

### Comparative Example 2

A battery is manufactured in the same manner as in Example 1 excepting that addition of LiBF₄ to the electrolytic solution is not carried out, and the amount of BP to be added to the electrolytic solution is 0.5% by mass.

### Comparative Example 3

A battery is manufactured in the same manner as in Example 1 excepting that addition of LiBF₄ to the electrolytic solution is not carried out, and the amount of BP to be added to the electrolytic solution is 4% by mass.

### Comparative Example 4

A battery is manufactured in the same manner as in Example 1 excepting that the amount of LiBF₄ and the amount of BP to be added to the electrolytic solution are 0.005% by mass and 0.1% by mass respectively.

### Comparative Example 5

A battery is manufactured in the same manner as in Example 1 excepting that the amount of LiBF₄ and the amount of BP to be added to the electrolytic solution are 0.005% by mass and 0.5% by mass respectively.

### Comparative Example 6

A battery is manufactured in the same manner as in Example 1 excepting that the amount of LiBF₄ and the amount of BP to be added to the electrolytic solution are 0.005% by mass and 4% by mass respectively.

### Comparative Example 7

A battery is manufactured in the same manner as in Example 1 excepting that addition of BP to the electrolytic solution is not carried out.

### Comparative Example 8

A battery is manufactured in the same manner as in Example 1 excepting that the amount of BP to be added to the electrolytic solution is 0.05% by mass.

### Comparative Example 9

A battery is manufactured in the same manner as in Example 1 excepting that the amount of BP to be added to the electrolytic solution is 5% by mass.

### Comparative Example 10

A battery is manufactured in the same manner as in Example 1 excepting that addition of BP to the electrolytic solution is not carried out, and the amount of LiBF₄ to be added to the electrolytic solution is 0.2% by mass.

### Comparative Example 11

A battery is manufactured in the same manner as in Example 1 excepting that the amount of LiBF₄ and the amount of BP to be added to the electrolytic solution are 0.2% by mass and 0.05% by mass respectively.

### Comparative Example 12

A battery is manufactured in the same manner as in Example 1 excepting that the amount of LiBF₄ and the amount of BP to be added to the electrolytic solution are 0.2% by mass and 5% by mass respectively.

### Comparative Example 13

A battery is manufactured in the same manner as in Example 1 excepting that addition of BP to the electrolytic solution is not carried out, and the amount of LiBF₄ to be added to the electrolytic solution is 2% by mass.

### Comparative Example 14

A battery is manufactured in the same manner as in Example 1 excepting that the amount of LiBF₄ and the amount of BP to be added to the electrolytic solution are 2% by mass and 0.05% by mass respectively.

### Comparative Example 15

A battery is manufactured in the same manner as in Example 1 excepting that the amount of LiBF₄ and the amount of BP to be added to the electrolytic solution are 2% by mass and 5% by mass respectively.

### Comparative Example 16

A battery is manufactured in the same manner as in Example 1 excepting that the amount of LiBF₄ and the amount of BP to be added to the electrolytic solution are 3% by mass and 0.1% by mass respectively.

### Comparative Example 17

A battery is manufactured in the same manner as in Example 1 excepting that the amount of LiBF₄ and the amount of BP to be added to the electrolytic solution are 3% by mass and 0.5% by mass respectively.

### Comparative Example 18

A battery is manufactured in the same manner as in Example 1 excepting that the amount of LiBF₄ and the amount of BP to be added to the electrolytic solution are 3% by mass and 4% by mass respectively.

### Comparative Example 19

A battery is manufactured in the same manner as in Example 10 excepting that 3.0% by mass of vinylene carbonate (VC) is further added relative to the total mass of the electrolytic solution.

### Comparative Example 20

A battery is manufactured in the same manner as in Example 10 excepting that 5.0% by mass of VC is further added relative to the total mass of the electrolytic solution.

### Comparative Example 21

A battery is manufactured in the same manner as in Comparative Example 10 excepting that LiNiO₂ is used as the positive electrode active material instead of LiCoO₂.

### Comparative Example 22

A battery is manufactured in the same manner as in Comparative Example 10 excepting that LiMn₂O₄ is used as the positive electrode active material instead of LiCoO₂.

### Comparative Example 23

A battery is manufactured in the same manner as in Comparative Example 10 excepting that LiNi_{0.4}Co_{0.3}Mn_{0.3}O₂ is used as the positive electrode active material instead of LiCoO₂.

### Comparative Example 24

A battery is manufactured in the same manner as in Example 1 excepting that addition of LiBF4 to the electrolytic solution is not carried out, and the amount of biphenyl (BP) to be added to the electrolytic solution is 1% by mass.

### Comparative Example 25

A battery is manufactured in the same manner as in Example 1 excepting that the amount of BP to be added to the electrolytic solution is 0.1% by mass, and 0.01% by mass of LiFOB is added to the electrolytic solution instead of LiBF₄.

### Comparative Example 26

A battery is manufactured in the same manner as in Comparative Example 25 excepting that the amount of BP to be added to the electrolytic solution is 1% by mass.

### Comparative Example 27

A battery is manufactured in the same manner as in Comparative Example 25 excepting that the amount of BP to be added to the electrolytic solution is 4% by mass.

### Comparative Example 28

A battery is manufactured in the same manner as in Comparative Example 25 excepting that addition of BP to the electrolytic solution is not carried out, and the amount of LiFOB to be added to the electrolytic solution is 0.1% by mass.

### Comparative Example 29

A battery is manufactured in the same manner as in Comparative Example 25 excepting that the amount of LiFOB and the amount of BP to be added to the electrolytic solution are 0.1% by mass and 0.05% by mass respectively.

### Comparative Example 30

A battery is manufactured in the same manner as in Comparative Example 25 excepting that the amount of LiFOB and the amount of BP to be added to the electrolytic solution are 0.1% by mass and 5% by mass respectively.

### Comparative Example 31

A battery is manufactured in the same manner as in Comparative Example 25 excepting that addition of BP to the electrolytic solution is not carried out, and the amount of LiFOB to be added to the electrolytic solution is 1% by mass.

### Comparative Example 32

A battery is manufactured in the same manner as in Comparative Example 25 excepting that the amount of LiFOB and the amount of BP to be added to the electrolytic solution are 1% by mass and 0.05% by mass respectively.

### Comparative Example 33

A battery is manufactured in the same manner as in Comparative Example 25 excepting that the amount of LiFOB and the amount of BP to be added to the electrolytic solution are 1% by mass and 5% by mass respectively.

### Comparative Example 34

A battery is manufactured in the same manner as in Comparative Example 25 excepting that addition of BP to the electrolytic solution is not carried out, and the amount of LiFOB to be added to the electrolytic solution is 2% by mass.

### Comparative Example 35

A battery is manufactured in the same manner as in Comparative Example 25 excepting that the amount of LiFOB and the amount of BP to be added to the electrolytic solution are 2% by mass and 0.05% by mass respectively.

### Comparative Example 36

A battery is manufactured in the same manner as in Comparative Example 25 excepting that the amount of LiFOB and the amount of BP to be added to the electrolytic solution are 2% by mass and 5% by mass respectively.

### Comparative Example 37

A battery is manufactured in the same manner as in Comparative Example 25 excepting that the amount of LiFOB and the amount of BP to be added to the electrolytic solution are 3% by mass and 0.1% by mass respectively.

### Comparative Example 38

A battery is manufactured in the same manner as in Comparative Example 25 excepting that the amount of LiFOB and the amount of BP to be added to the electrolytic solution are 3% by mass and 1% by mass respectively.

### Comparative Example 39

A battery is manufactured in the same manner as in Comparative Example 25 excepting that the amount of LiFOB and the amount of BP to be added to the electrolytic solution are 3% by mass and 4% by mass respectively.

### Comparative Example 40

A battery is manufactured in the same manner as in Example 62 excepting that 3.0% by mass of vinylene carbonate (VC) is further added relative to the total mass of the electrolytic solution.

### Comparative Example 41

A battery is manufactured in the same manner as in Example 62 excepting that 5.0% by mass of VC is further added relative to the total mass of the electrolytic solution.

### Comparative Example 42

A battery is manufactured in the same manner as in Comparative Example 31 excepting that LiNiO₂ is used as the positive electrode active material instead of LiCoO₂.

### Comparative Example 43

A battery is manufactured in the same manner as in Comparative Example 31 excepting that LiMn₂O₄ is used as the positive electrode active material instead of LiCoO₂.

### Comparative Example 44

A battery is manufactured in the same manner as in Comparative Example 31 excepting that LiNi_{0.4}Co_{0.3}Mn_{0.3}O₂ is used as the positive electrode active material instead of LiCoO₂.

### Comparative Example 45

A battery is manufactured in the same manner as in Example 1 excepting that the amount of biphenyl (BP) to be added to the electrolytic solution is 0.1% by mass, and 0.01% by mass of LiBOB is added to the electrolytic solution instead of LiBF₄.

### Comparative Example 46

A battery is manufactured in the same manner as in Comparative Example 45 excepting that the amount of BP to be added to the electrolytic solution is 1% by mass.

### Comparative Example 47

A battery is manufactured in the same manner as in Comparative Example 45 excepting that the amount of BP to be added to the electrolytic solution is 4% by mass.

### Comparative Example 48

A battery is manufactured in the same manner as in Comparative Example 45 excepting that addition of BP to the electrolytic solution is not carried out, and the amount of LiBOB to be added to the electrolytic solution is 0.1% by mass.

### Comparative Example 49

A battery is manufactured in the same manner as in Comparative Example 45 excepting that the amount of LiBOB and the amount of BP to be added to the electrolytic solution are 0.1% by mass and 0.05% by mass respectively.

### Comparative Example 50

A battery is manufactured in the same manner as in Comparative Example 45 excepting that the amount of LiBOB and the amount of BP to be added to the electrolytic solution are 0.1% by mass and 5% by mass respectively.

### Comparative Example 51

A battery is manufactured in the same manner as in Comparative Example 45 excepting that addition of BP to the electrolytic solution is not carried out, and the amount of LiBOB to be added to the electrolytic solution is 1% by mass.

### Comparative Example 52

A battery is manufactured in the same manner as in Comparative Example 45 excepting that the amount of LiBOB and the amount of BP to be added to the electrolytic solution are 1% by mass and 0.05% by mass respectively.

### Comparative Example 53

A battery is manufactured in the same manner as in Comparative Example 45 excepting that the amount of LiBOB and the amount of BP to be added to the electrolytic solution are 1% by mass and 5% by mass respectively.

### Comparative Example 54

A battery is manufactured in the same manner as in Comparative Example 45 excepting that addition of BP to the electrolytic solution is not carried out, and the amount of LiBOB to be added to the electrolytic solution is 2% by mass.

### Comparative Example 55

A battery is manufactured in the same manner as in Comparative Example 45 excepting that the amount of LiBOB and the amount of BP to be added to the electrolytic solution are 2% by mass and 0.05% by mass respectively.

### Comparative Example 56

A battery is manufactured in the same manner as in Comparative Example 45 excepting that the amount of LiBOB and the amount of BP to be added to the electrolytic solution are 2% by mass and 5% by mass respectively.

### Comparative Example 57

A battery is manufactured in the same manner as in Comparative Example 45 excepting that the amount of LiBOB and the amount of BP to be added to the electrolytic solution are 3% by mass and 0.1% by mass respectively.

### Comparative Example 58

A battery is manufactured in the same manner as in Comparative Example 45 excepting that the amount of LiBOB and the amount of BP to be added to the electrolytic solution are 3% by mass and 1% by mass respectively.

### Comparative Example 59

A battery is manufactured in the same manner as in Comparative Example 45 excepting that the amount of LiBOB and the amount of BP to be added to the electrolytic solution are 3% by mass and 4% by mass respectively.

### Comparative Example 60

A battery is manufactured in the same manner as in Example 112 excepting that 3.0% by mass of vinylene carbonate (VC) is further added relative to the total mass of the electrolytic solution.

### Comparative Example 61

A battery is manufactured in the same manner as in Example 112 excepting that 5.0% by mass of VC is further added relative to the total mass of the electrolytic solution.

### Comparative Example 62

A battery is manufactured in the same manner as in Comparative Example 51 excepting that LiNiO₂ is used as the positive electrode active material instead of LiCoO₂.

### Comparative Example 63

A battery is manufactured in the same manner as in Comparative Example 51 excepting that LiMn₂O₄ is used as the positive electrode active material instead of LiCoO₂.

### Comparative Example 64

A battery is manufactured in the same manner as in Comparative Example 51 excepting that LiNi_{0.4}Co_{0.3}Mn_{0.3}O₂ is used as the positive electrode active material instead of LiCoO₂.

For the batteries of the examples and comparative examples described above, the initial capacity (mAh) and initial battery thickness (mm) are measured. For each battery, capacity retention (%) after repetition of charging and discharging and increase in thickness (mm) and capacity recovery ratio (%) after left in high temperature environments are measured. For measurement of the initial capacity and initial battery thickness, each 5 cells of the batteries of the examples and comparative examples are manufactured and, the manufactured batteries were charged for 3 hours with a current of 600 mA up to 4.2 V under constant current and constant voltage, thereafter, discharged with a current of 600 mA up to 3 V, and the discharge capacity (initial capacity) and battery thickness (initial battery thickness) are measured, and averaged.

For the capacity retention, a charging and discharging cycle is repeated 500 times under the same conditions as for measurement of the initial capacity, and the capacity retention at 500-th cycle relative to the initial capacity is calculated (=100×discharge capacity at 500-th cycle/initial capacity). For measurement of increase in thickness and capacity recovery ratio after left in high temperature environments, the manufactured batteries are charged for 3 hours with a current of 600 mA up to 4.2 V under constant current and constant voltage and the battery thickness is measured, then, left for 100 hours in a constant temperature bath of 85° C., and the battery thickness is measured, and a difference in battery thickness before and after being left (increase in thickness) is calculated. Thereafter, the batteries are left for 5 hours at 25° C., and the discharge capacity is measured under the same conditions as for measurement of the initial capacity, and the ratio relative to the initial capacity (=100×discharge capacity measured/initial capacity:recovery ratio) is calculated.

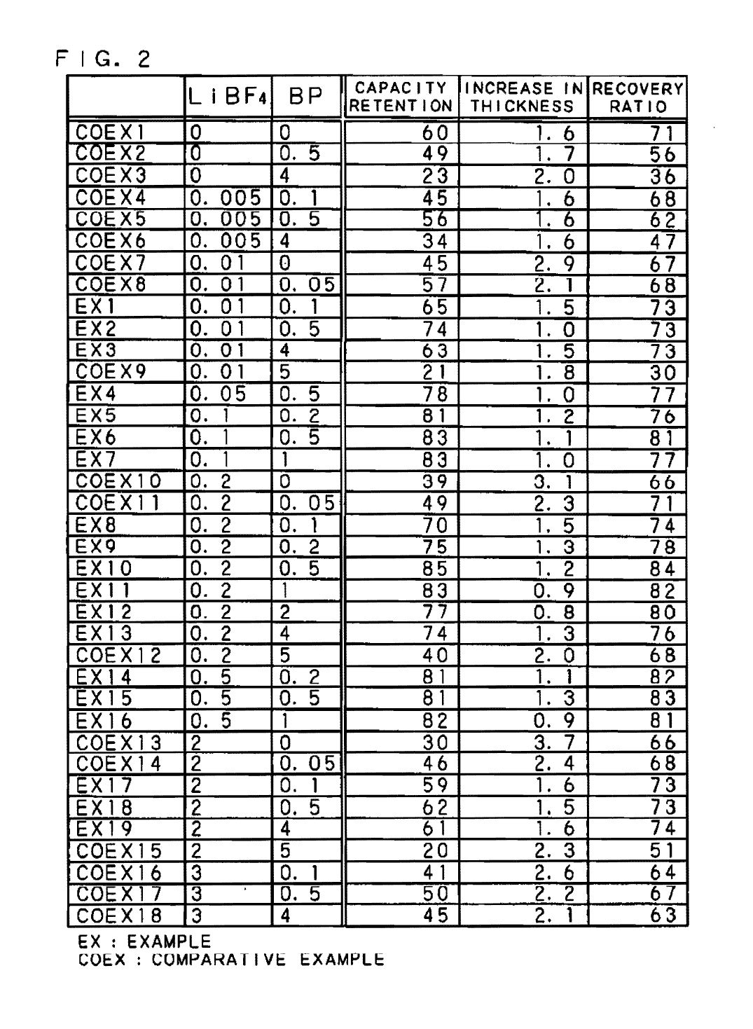

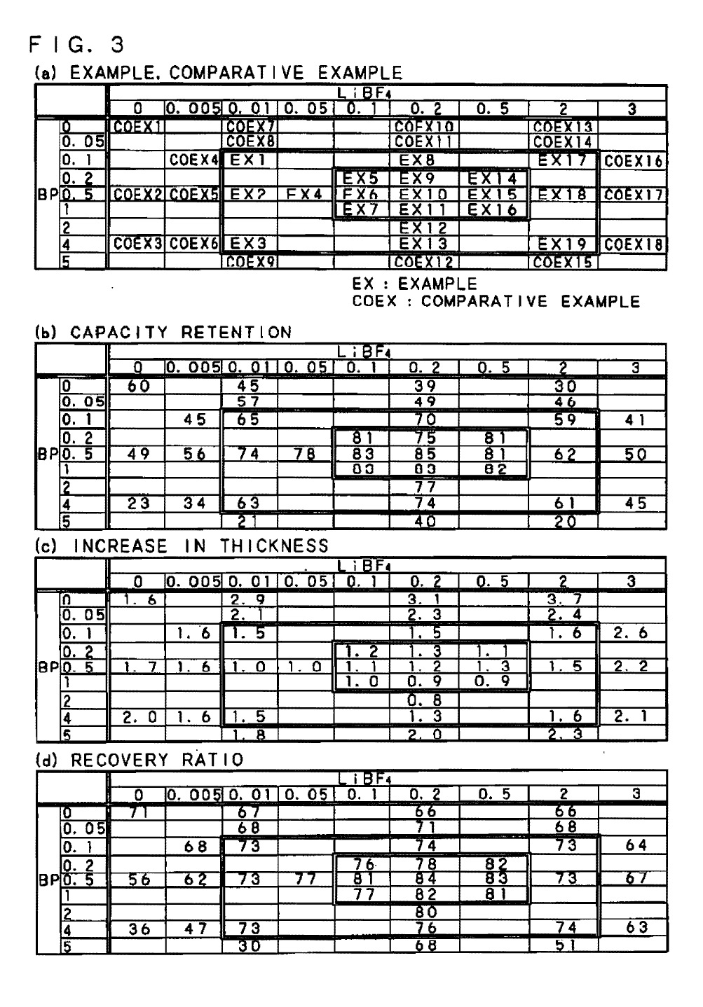

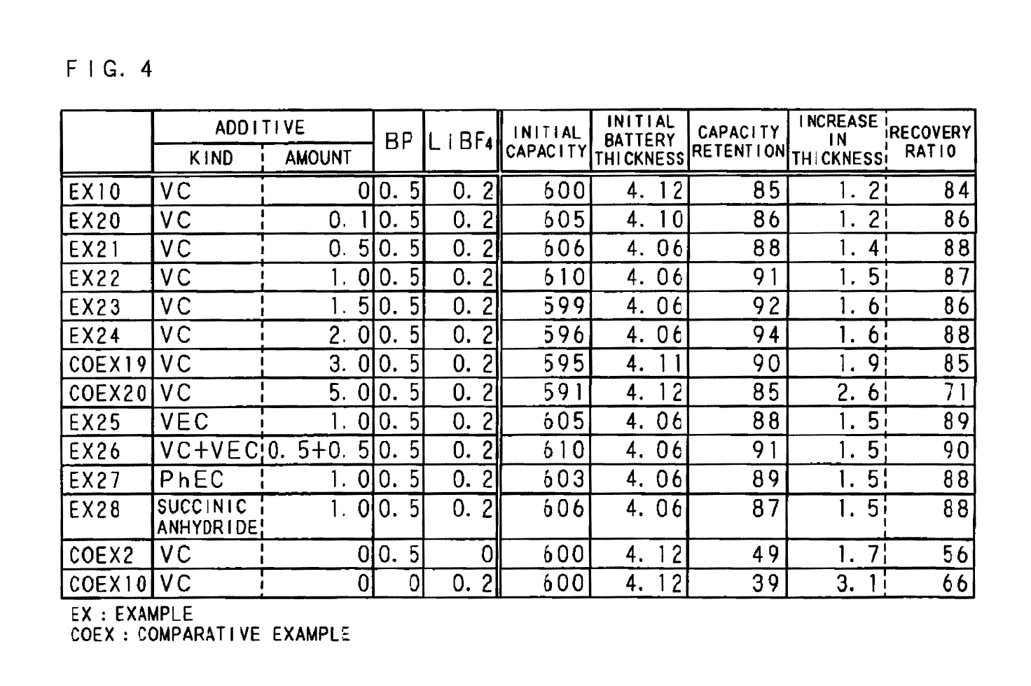

The measurement results of the capacity retention, thickness increase and recovery ratio of the batteries obtained by adding LiBF₄ to the electrolytic solution are shown in FIG. 2, and the results partially extracted from FIG. 2 and rearranged are shown in FIGS. 3(a) to (d). The measurement results of the initial capacity, initial battery thickness, capacity retention, thickness increase and recovery ratio of the batteries obtained by adding LiBF₄ to the electrolytic solution are shown in FIGS. 4 to 7.

As shown in FIGS. 2 and 3(a) to (d), when LiBF₄ is added singly to the electrolytic solution, there is a tendency that as the addition amount is larger, the capacity retention is smaller, the thickness increase is larger, and the recovery ratio is smaller. Also when biphenyl (BP) is added singly to the electrolytic solution, there is a tendency that as the addition amount is larger, the capacity retention is smaller, the thickness increase is larger, and the recovery ratio is smaller.

On the other hand, when both LiBF₄ and BP are added to the electrolytic solution, there is a tendency of larger capacity retention, smaller thickness increase and larger recovery ratio. However, when the addition amount of LiBF₄ is 0.005% by mass and when the addition amount is 3% by mass, the effect by addition of LiBF₄ is small, and when the addition amount is not less than 0.01% by mass and not more than 2% by mass, an excellent effect is obtained. Of them, when the addition amount is not less than 0.1% by mass and not more than 0.5% by mass, a more excellent effect is obtained. The addition amount of LiBF₄ is preferably not less than 0.01% by mass and not more than 2% by mass, more preferably not less than 0.1% by mass and not more than 0.5% by mass.

When the addition amount of BP is 0.05% by mass and when the addition amount is 5% by mass, the effect by addition of BP is small, and when the addition amount is not less than 0.1% by mass and not more than 4% by mass, an excellent effect is obtained. Of them, when the addition amount is not less than 0.2% by mass and not more than 1% by mass, a more excellent effect is obtained. The addition amount of BP is preferably not less than 0.1% by mass and not more than 4% by mass, more preferably not less than 0.2% by mass and not more than 1% by mass.

As shown in FIG. 4, when vinylene carbonate (VC), vinylethylene carbonate (VEC), phenylethylene carbonate (PhEC) or succinic anhydride is added, to the electrolyte, there is a tendency of smaller initial battery thickness and larger recovery ratio. However, when the addition amount is 0.1% by mass, the effect by addition is small, and when the addition amount is not less than 3% by mass, the thickness increase and initial battery thickness increase. The addition amount of VC is preferably not less than 0.1% by mass and not more than 2% by mass, more preferably not less than 0.5% by mass and not more than 2% by mass. For additives other than VC, it is believed that change of the effect depending on increase or decrease of the addition amount shows the same tendency as for VC because of natures analogous to VC. It is also possible that VC and other additives are used in admixture. For example, in the case of Example 26, the initial capacity and capacity retention are improved.

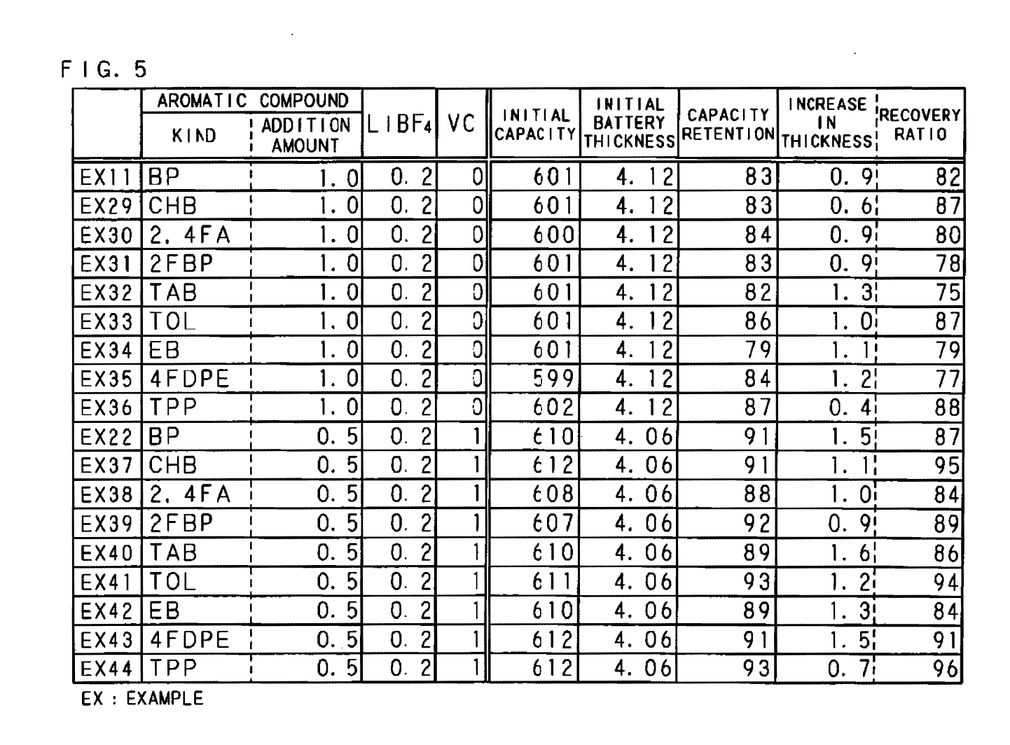

As shown in FIG. 5, also when aromatic compounds other than BP are added, the same effect as for BP is obtained. Of them, when TPP is added, the increase in thickness is suppressed successfully. It is also possible that a plurality of kinds of aromatic compounds are used in admixture.

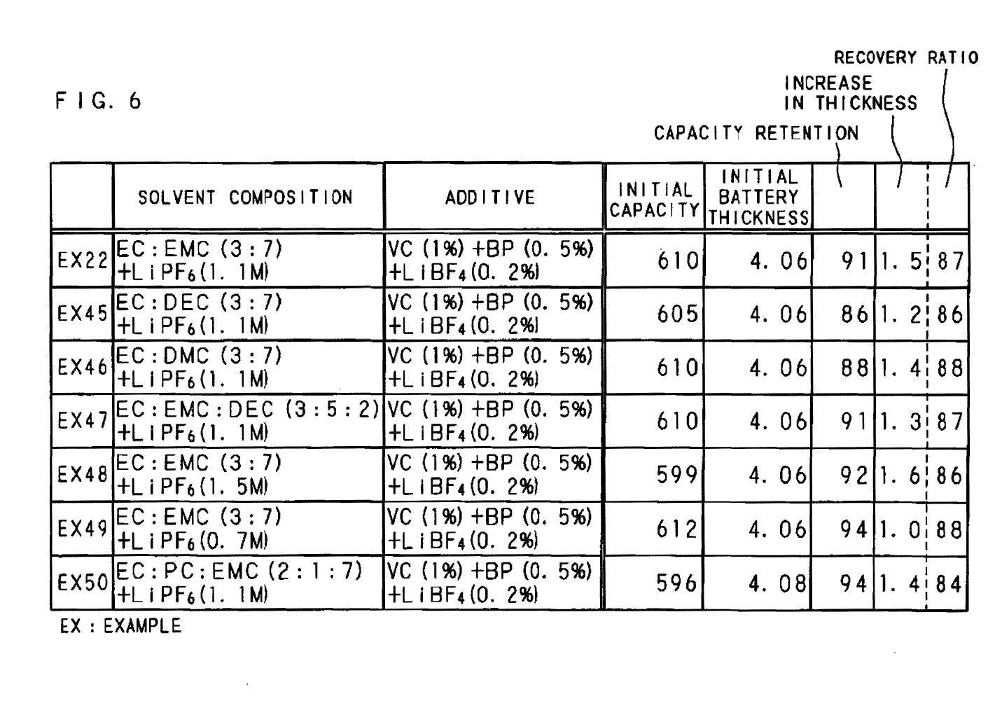

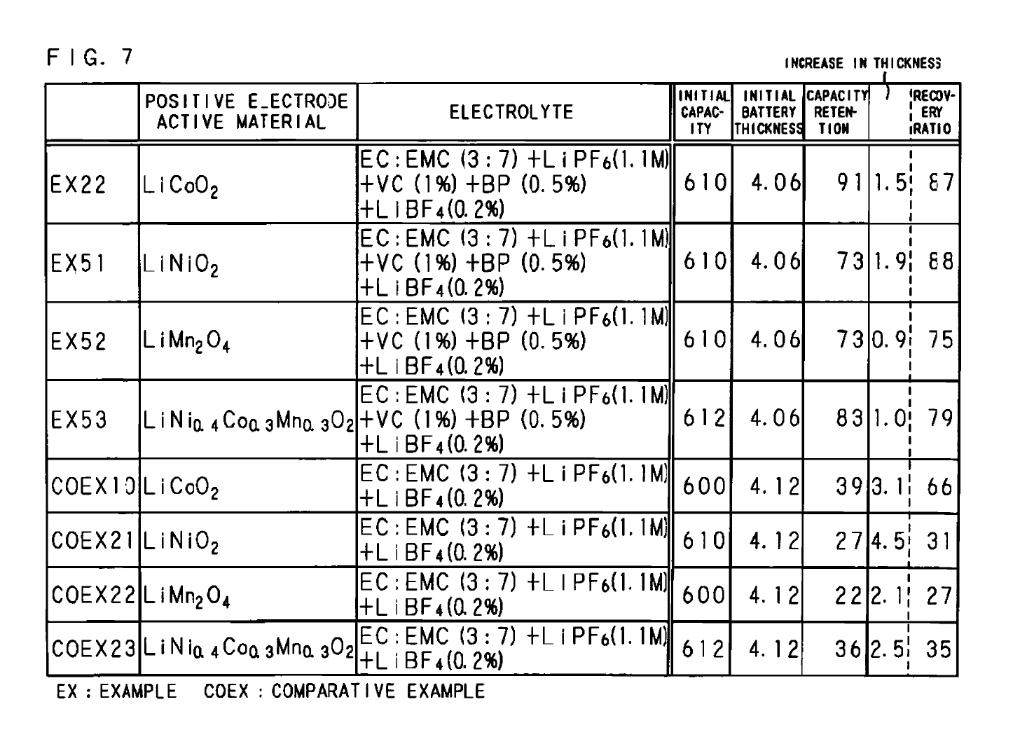

As shown in FIG. 6, also when the solvent composition of the electrolyte or the concentration of LiPF₆ are changed, the effect of the present invention is obtained. As shown in FIG. 7, also when the positive electrode active material is changed, the effect of the present invention is obtained. Of them, the thickness increase is suppressed successfully in Example 52 and 53 using Mn.

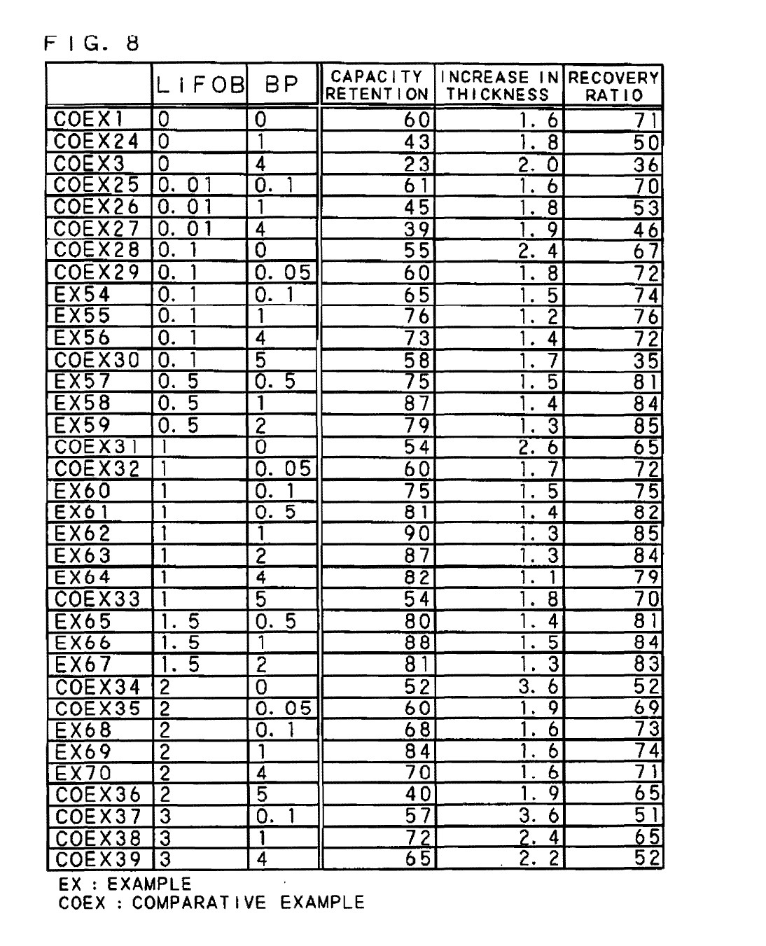

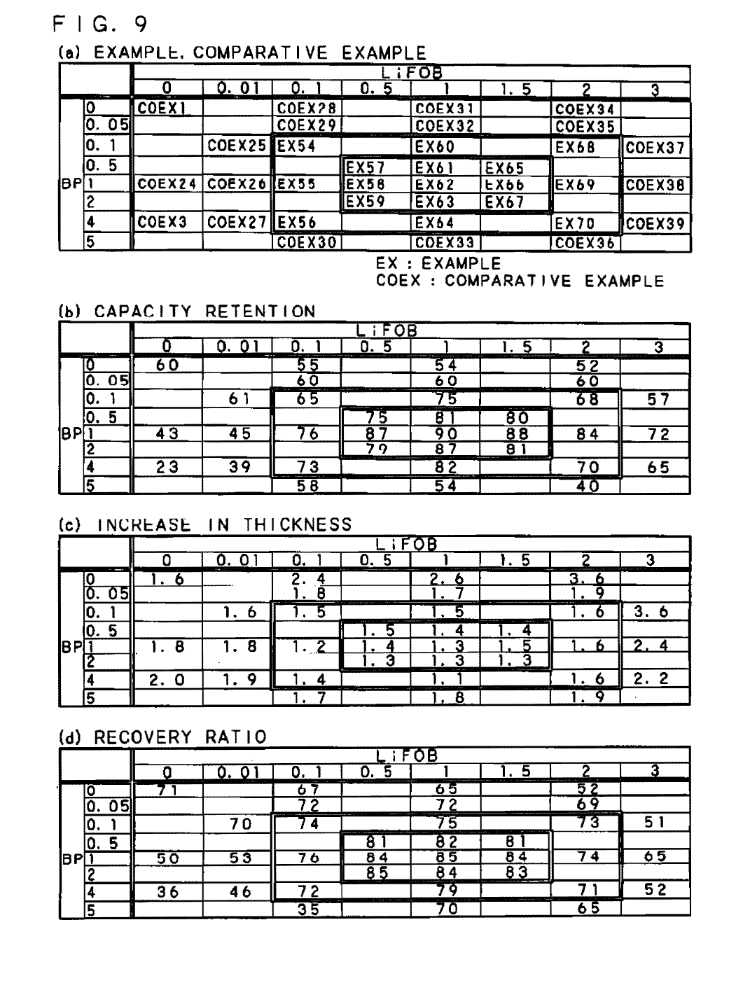

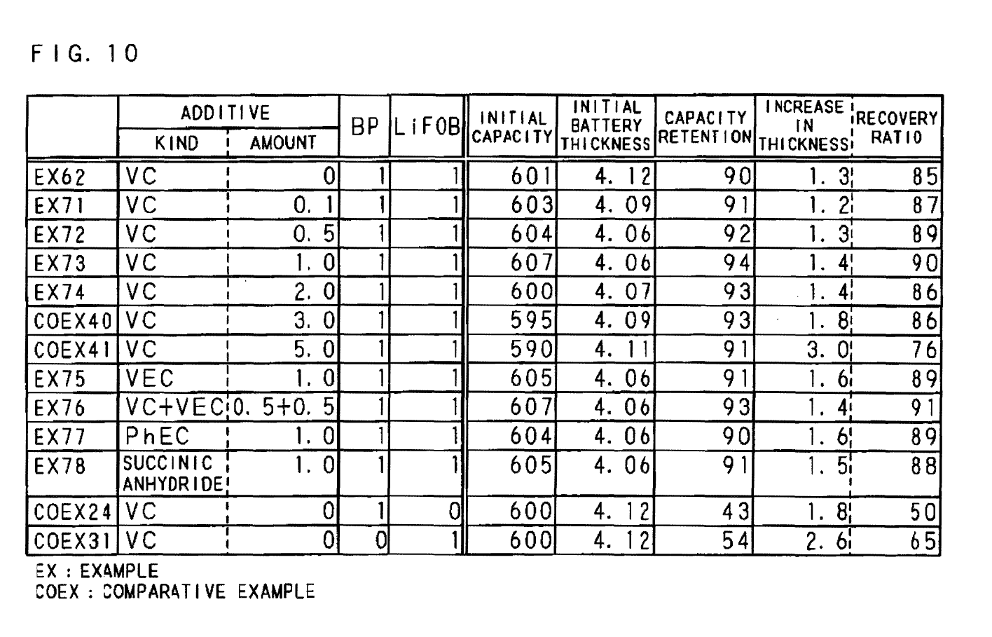

The measurement results of the capacity retention, thickness increase and recovery ratio of the batteries obtained by adding LiFOB to the electrolytic solution are shown in FIG. 8, and the results partially extracted from FIG. 8 and rearranged are shown in FIGS. 9(a) to (d). The measurement results of the initial capacity, initial battery thickness, capacity retention, thickness increase and recovery ratio of the batteries obtained by adding LiFOB to the electrolytic solution are shown in FIGS. 10 to 13.

As shown in FIGS. 8 and 9(a) to (d), when LiFOB is added singly to the electrolytic solution, there is a tendency that as the addition amount is larger, the capacity retention is smaller, the thickness increase is larger, and the recovery ratio is smaller. Also when biphenyl (BP) is added singly to the electrolytic solution, there is a tendency that as the addition amount is larger, the capacity retention is smaller, the thickness increase is larger, and the recovery ratio is smaller.

On the other hand, when both LiFOB and BP are added to the electrolytic solution, there is a tendency of larger capacity retention, smaller thickness increase and larger recovery ratio. However, when the addition amount of LiFOB is 0.01% by mass and when the addition amount is 3% by mass, the effect by addition of LiFOB is small, and when the addition amount is not less than 0.1% by mass and not more than 2% by mass, an excellent effect is obtained. Of them, when the addition amount is not less than 0.5% by mass and not more than 1.5% by mass, a more excellent effect is obtained. The addition amount of LiFOB is preferably not less than 0.1% by mass and not more than 2% by mass, more preferably not less than 0.5% by mass and not more than 1.5% by mass.

When the addition amount of BP is 0.05% by mass and when the addition amount is 5% by mass, the effect by addition of BP is small, and when the addition amount is not less than 0.1% by mass and not more than 4% by mass, an excellent effect is obtained. When the addition amount is not less than 0.5% by mass and not more than 2% by mass, a more excellent effect is obtained. The addition amount of BP is preferably not less than 0.1% by mass and not more than 4% by mass, more preferably not less than 0.5% by mass and not more than 2% by mass.

As shown in FIG. 10, when vinylene carbonate (VC), vinylethylene carbonate (VEC), phenylethylene carbonate (PhEC) or succinic anhydride is added to the electrolyte, there is a tendency of smaller initial battery thickness and larger initial capacity and larger recovery ratio. However, when the addition amount is 0.1% by mass, the effect by addition is small, and when the addition amount is not less than 3% by mass, the thickness increase and initial battery thickness increase. The addition amount of VC is preferably not less than 0.1% by mass and not more than 2% by mass, more preferably not less than 0.5% by mass and not more than 1% by mass. For additives other than VC, it is believed that change of the effect depending on increase or decrease of the addition amount shows the same tendency as for VC because of natures analogous to VC. It is also possible that VC and other additives are used in admixture. For example, in the case of Example 76, the initial capacity, capacity retention and recovery ratio are improved.

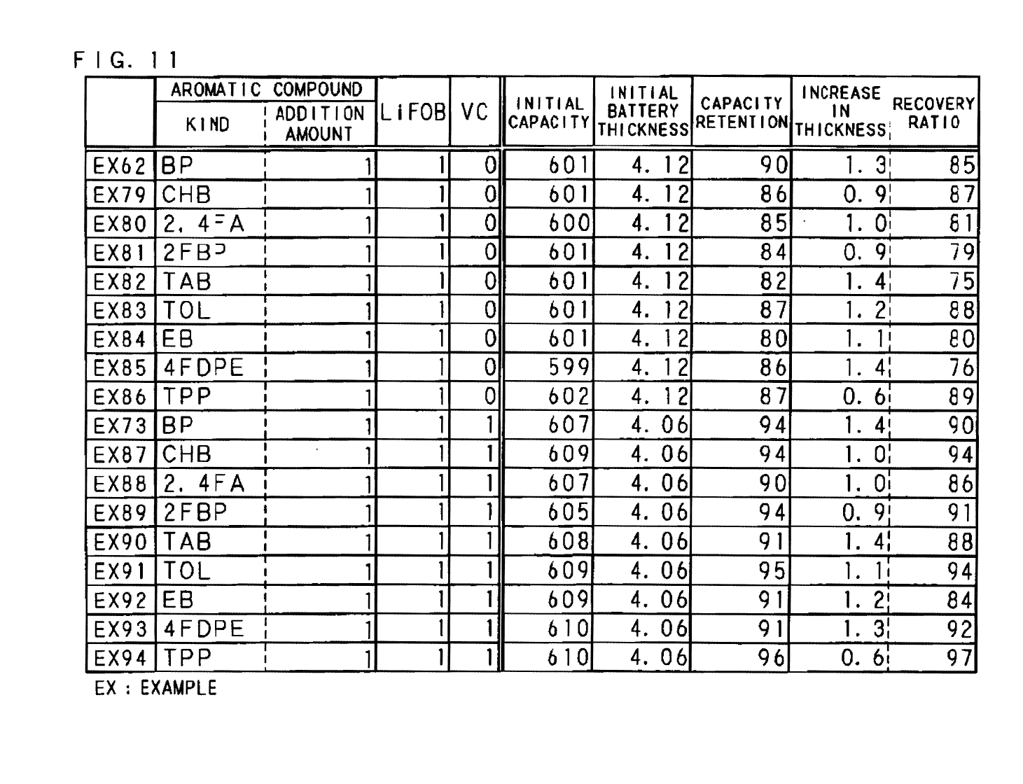

As shown in FIG. 11, also when aromatic compounds other than BP are added, the same effect as for BP is obtained. Of them, when TPP is added, the increase in thickness is suppressed successfully. It is also possible that a plurality of kinds of aromatic compounds are used in admixture.

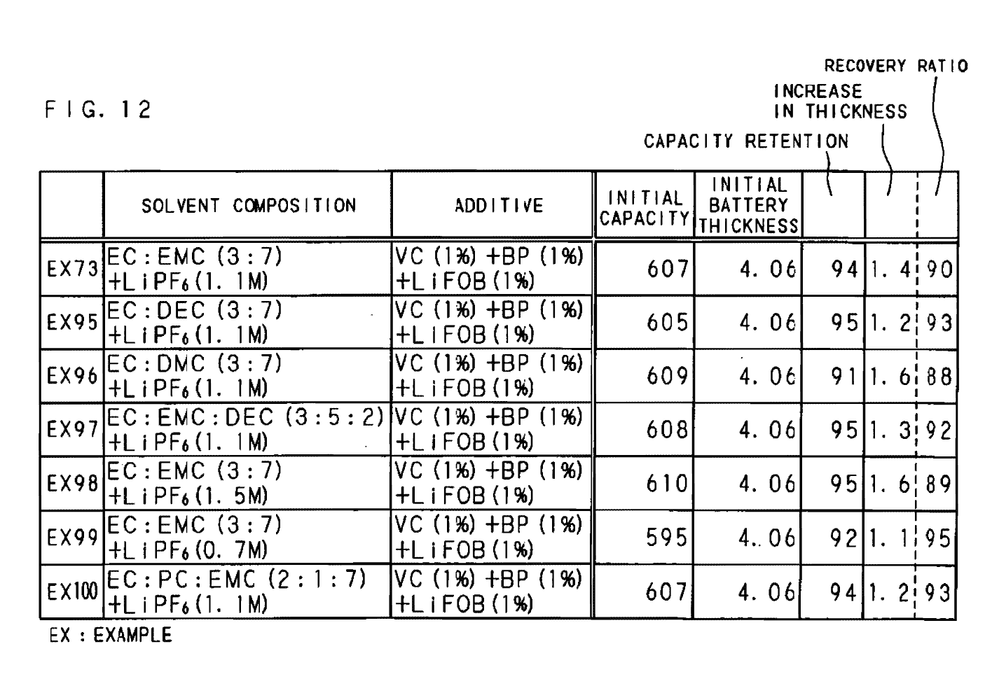

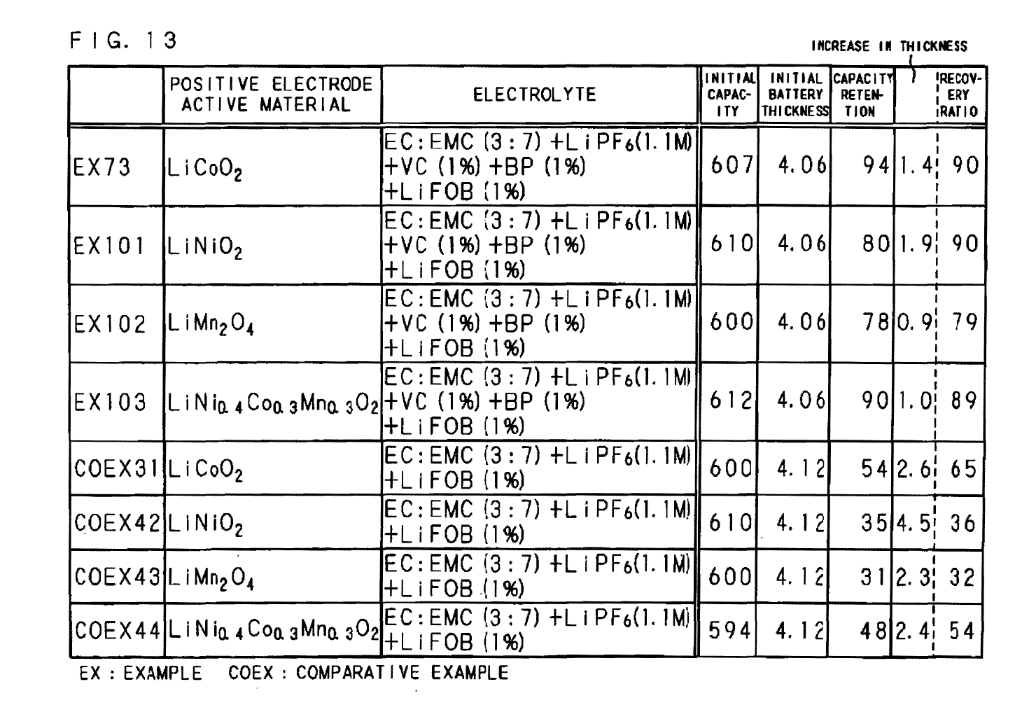

As shown in FIG. 12, also when the solvent composition of the electrolyte or the concentration of LiPF₆ are changed, the effect of the present invention is obtained. When LiFOB is added, the initial capacity increases also in an electrolytic solution containing PC as in Example 100. The reason for this is believed to be a fact that in an electrolytic solution containing PC, the decomposition of PC is suppressed because of a negative electrode film formed by LiFOB. As shown in FIG. 13, also when the positive electrode active material is changed, the effect of the present invention is obtained. Of them, the thickness increase is suppressed successfully in Example 102 and 103 using Mn.

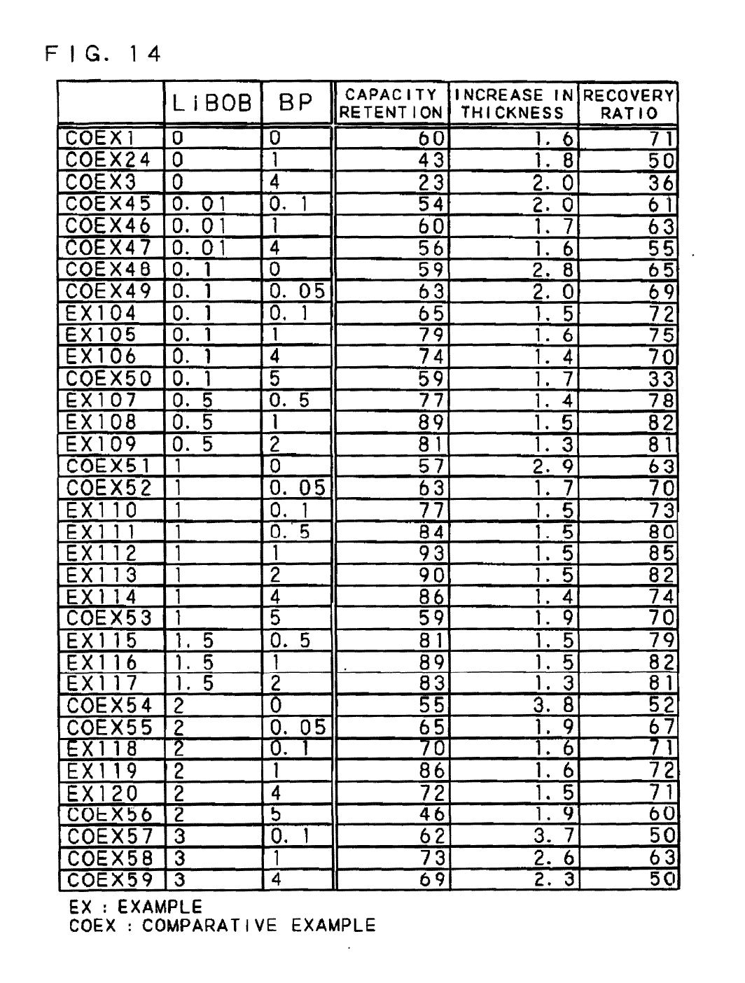

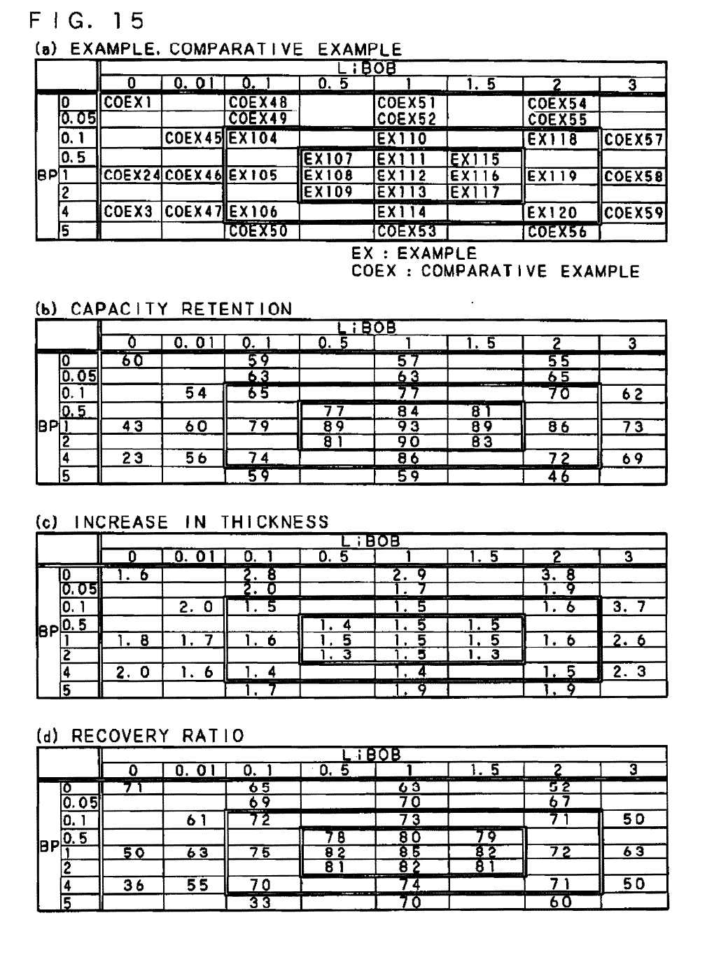

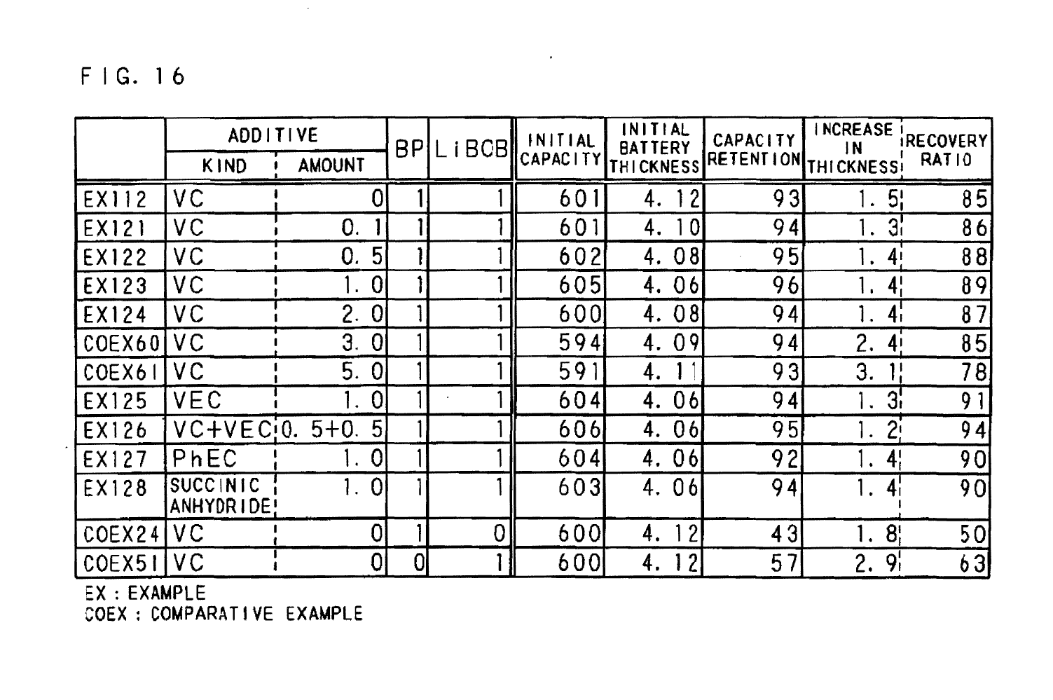

The measurement results of the capacity retention, thickness increase and recovery ratio of the batteries obtained by adding LiBOB to the electrolytic solution are shown in FIG. 14, and the results partially extracted from FIG. 14 and rearranged are shown in FIGS. 15(a) to (d). The measurement results of the initial capacity, initial battery thickness, capacity retention, thickness increase and recovery ratio of the batteries obtained by adding LiBOB to the electrolytic solution are shown in FIGS. 16 to 19.

As shown in FIGS. 14 and 15(a) to (d), when LiFOB is added singly to the electrolytic solution, there is a tendency that as the addition amount is larger, the capacity retention is smaller, the thickness increase is larger, and the recovery ratio is smaller. Also when biphenyl (BP) is added singly to the electrolytic solution, there is a tendency that as the addition amount is larger, the capacity retention is smaller, the thickness increase is larger, and the recovery ratio is smaller.

On the other hand, when both LiBOB and BP are added to the electrolytic solution, there is a tendency of larger capacity retention, smaller thickness increase and larger recovery ratio. However, when the addition amount of LiBOB is 0.01% by mass and when the addition amount is 38% by mass, the effect by addition of LiBOB is small, and when the addition amount is not less than 0.1% by mass and not more than 2% by mass, an excellent effect is obtained. Of them, when the addition amount is not less than 0.5% by mass and not more than 1.5% by mass, a more excellent effect is obtained. The addition amount of LiBOB is preferably not less than 0.1% by mass and not more than 2% by mass, more preferably not less than 0.5% by mass and not more than 1.5% by mass.

When the addition amount of BP is 0.05% by mass and when the addition amount is 5% by mass, the effect by addition of BP is small, and when the addition amount is not less than 0.1% by mass and not more than 4% by mass, an excellent effect is obtained. When the addition amount is not less than 0.5% by mass and not more than 2% by mass, a more excellent effect is obtained. The addition amount of BP is preferably not less than 0.1% by mass and not more than 4% by mass, more preferably not less than 0.5% by mass and not more than 2% by mass.

As shown in FIG. 16, when vinylene carbonate (VC), vinylethylene carbonate (VEC), phenylethylene carbonate (PhEC) or succinic anhydride is added to the electrolyte, there is a tendency of smaller initial battery thickness and larger initial capacity and larger recovery ratio. However, when the addition amount is 0.1% by mass, the effect by addition is small, and when the addition amount is not less than 3% by mass, the thickness increase and initial battery thickness increase. The addition amount of VC is preferably not less than 0.1% by mass and not more than 2% by mass, more preferably not less than 0.5% by mass and not more than 1% by mass. For additives other than VC, it is believed that change of the effect depending on increase or decrease of the addition amount shows the same tendency as for VC because of natures analogous to VC. It is also possible that VC and other additives are used in admixture. For example, in the case of Example 126, the initial capacity, capacity retention and recovery ratio are improved.

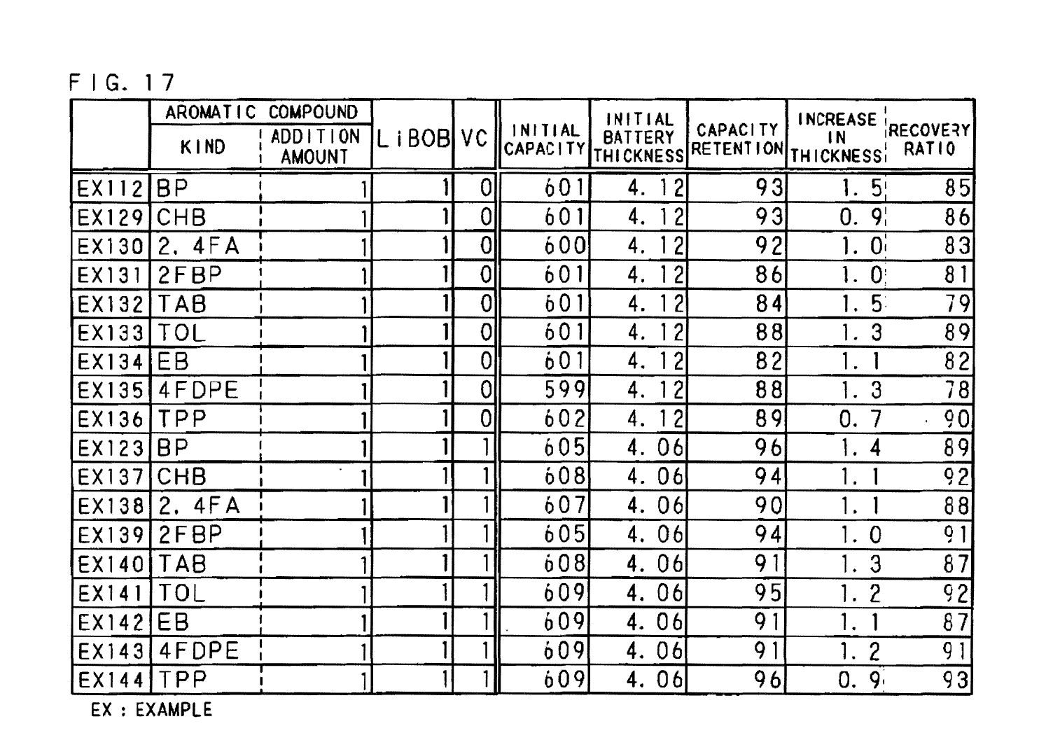

As shown in FIG. 17, also when aromatic compounds other than BP are added, the same effect as for BP is obtained. Of them, when TPP is added, the increase in thickness is suppressed successfully. It is also possible that a plurality of kinds of aromatic compounds are used in admixture.

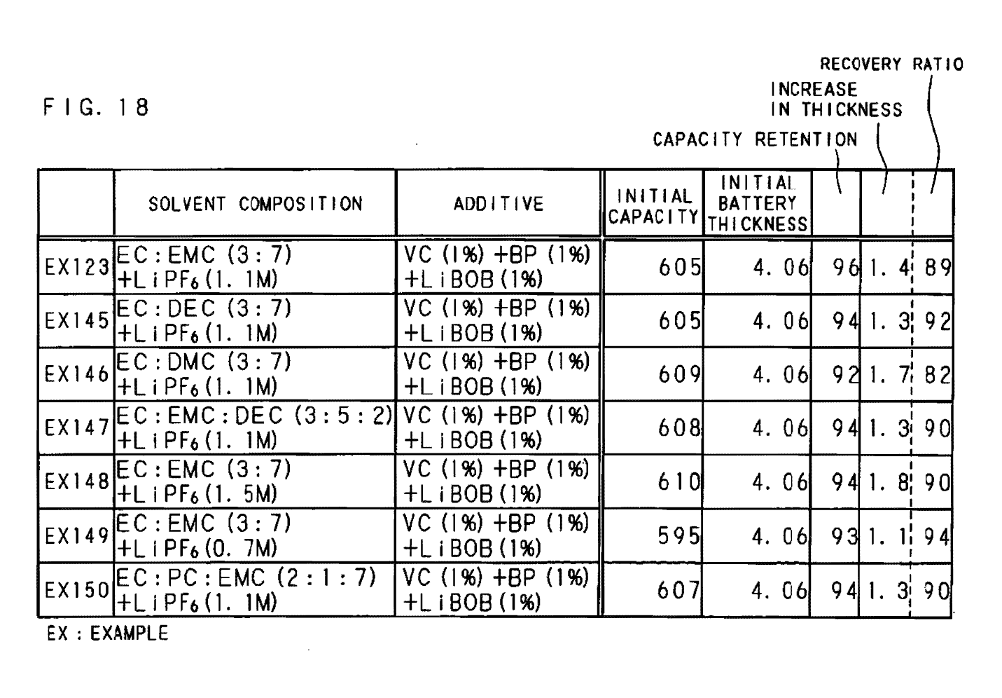

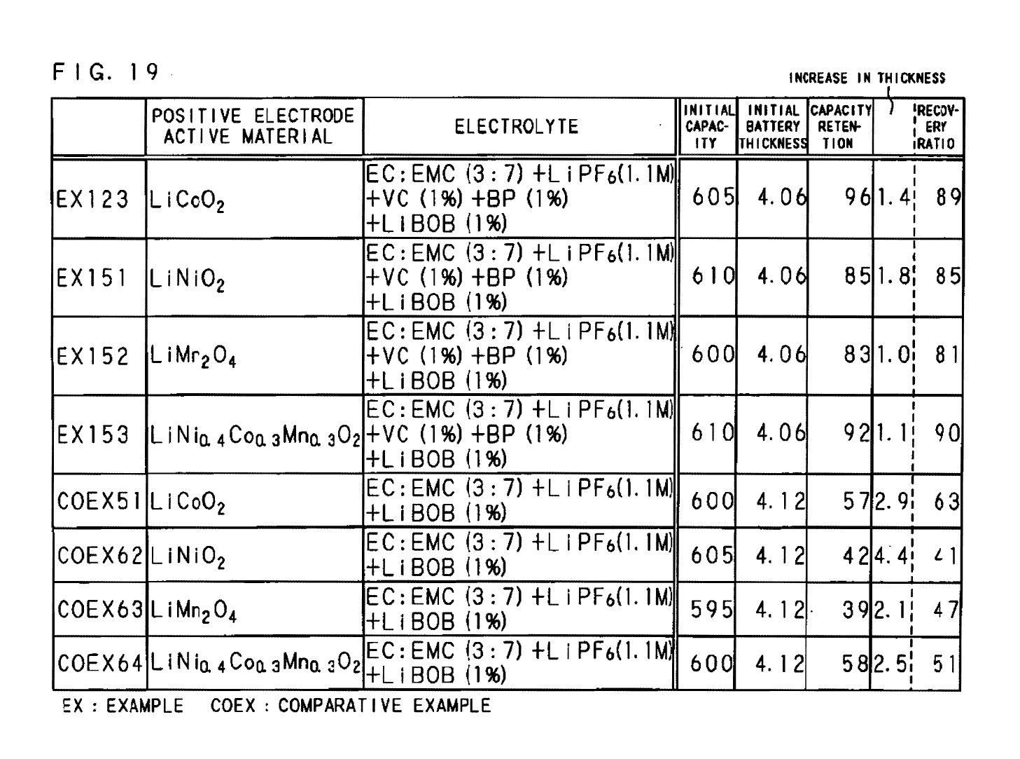

As shown in FIG. 18, also when the solvent composition of the electrolyte or the concentration of LiPF₆ are changed, the effect of the present invention is obtained. When LiBOB is added, the initial capacity increases also in an electrolytic solution containing PC as in Example 150. The reason for this is believed to be a fact that in an electrolytic solution containing PC, the decomposition of PC is suppressed because of a negative electrode film formed by LiBOB. As shown in FIG. 19, also when the positive electrode active material is changed, the effect of the present invention is obtained. Of them, the thickness increase is suppressed successfully in Example 152 and 153 using Mn.

Though LiBF₄, LiFOB or LIBOB is used singly in the examples described above, the same effect is obtained also when any two or all kinds of LiBF₄, LiFOB and LIBOB are used in admixture since the effect when an aromatic compound is added is the same. Therefore, it is possible to use LiBF₄, LiFOB and LIBOB in admixtures, and it is preferable that the total addition amount thereof is not more than 2% by mass relative to the total mass of the electrolytic solution.

1. A nonaqueous electrolyte secondary battery, comprising:
a positive electrode containing a lithium complex oxide including nickel, cobalt and manganese;
a negative electrode which adsorbs/desorbs lithium;
a rectangular cylindrical battery case including an opening and a bottom;
a battery cap sealing the opening of the battery case; and
a nonaqueous electrolyte which is accommodated in the battery case,
wherein an electrode group obtained by winding about an axis the positive electrode and the negative electrode via a separator is in a form of flat, and is accommodated in the battery case so that the axis of the electrode, group is parallel to the battery cap,
said nonaqueous electrolyte is made with LiPF₆, an aromatic compound, and a compound of the formula (1), and
the aromatic compound is one or more kinds of compounds selected from the group consisting of biphenyl, cyclohexylbenzene, 2,4-difluoroanisole, 2-fluorobiphenyl, tertiary amylbenzene, toluene, ethylbenzene, 4-fluorodiphenyl ether and triphenyl phosphate

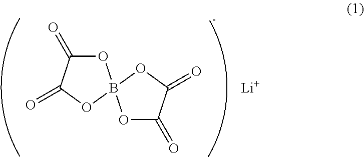

2. The nonaqueous electrolyte secondary battery according to claim 1, wherein said nonaqueous electrolyte contains the compound of the formula (1) in an amount of not less than 0.1% by mass and not more than 2% by mass relative to the total mass of the nonaqueous electrolyte, and the aromatic compound in an amount of not less than 0.1% by mass and not more than 4% by mass relative to the total mass of the nonaqueous electrolyte.

3. The nonaqueous electrolyte secondary battery according to claim 1, wherein said nonaqueous electrolyte contains ethylene carbonate and diethylene carbonate.

4. The nonaqueous electrolyte secondary battery according to claim 2, wherein said nonaqueous electrolyte contains ethylene carbonate and diethylene carbonate.

5. The nonaqueous electrolyte secondary battery according to claim 1, wherein said nonaqueous electrolyte contains ethylene carbonate, ethyl methyl carbonate, and diethylene carbonate.

6. The nonaqueous electrolyte secondary battery according to claim 2, wherein said nonaqueous electrolyte contains ethylene carbonate, ethyl methyl carbonate, and diethylene carbonate.

7. The nonaqueous electrolyte secondary battery according to claim 1, wherein said nonaqueous electrolyte contains one or more kinds of compounds selected from the group consisting of vinylene carbonate, vinylethylene carbonate, phenylethylene carbonate and cyclic carboxylic anhydrides.

8. The nonaqueous electrolyte secondary battery according to claim 2, wherein said nonaqueous electrolyte contains one or more kinds of compounds selected from the group consisting of vinylene carbonate, vinylethylene carbonate, phenylethylene carbonate and cyclic carboxylic anhydrides.

9. The non aqueous electrolyte secondary battery according to claim 3, wherein said nonaqueous electrolyte contains one or more kinds of compounds selected from the group consisting of vinylene carbonate, vinylethylene carbonate, phenylethylene carbonate and cyclic carboxylic anhydrides.

10. The nonaqueous electrolyte secondary battery according to claim 4, wherein said nonaqueous electrolyte contains one or more kinds of compounds selected from the group consisting of vinylene carbonate, vinylethylene carbonate, phenylethylene carbonate and cyclic carboxylic anhydrides.

11. The nonaqueous electrolyte secondary battery according to claim 5, wherein said nonaqueous electrolyte contains one or more kinds of compounds selected from the group consisting of vinylene carbonate, vinylethylene carbonate, phenylethylene carbonate and cyclic carboxylic anhydrides.

12. The nonaqueous electrolyte secondary battery according to claim 6, wherein said nonaqueous electrolyte contains one or more kinds of compounds selected from the group consisting of vinylene carbonate, vinylethylene carbonate, phenylethylene carbonate and cyclic carboxylic anhydrides.
